(19) United States
(12) Patent Application Publication
(10) Pub. No.: US 2024/0134818 A1
(43) Pub. Date: Apr. 25, 2024

(54) PROGRAMMABLE PROCESSING ARRAY SUPPORTING MULTI-DIMENSIONAL INTERPOLATION COMPUTATIONS

(71) Applicant: Intel Corporation, Santa Clara, CA (US)

(72) Inventors: Zoran Zivkovic, Hertogenbosch (NL); Jian-Guo Chen, Basking Ridge, NJ (US); Jay ONeill, Nesquehoning, PA (US); Joseph Williams, Holmdel, NJ (US)

(21) Appl. No.: 18/533,369

(22) Filed: Dec. 8, 2023

(51) Int. Cl. G06F 15/80; G06F 1/03

(52) U.S. Cl. CPC G06F 15/8007; G06F 1/03

(57) ABSTRACT

Techniques are disclosed for a programmable processor architecture that enables data interpolation using an architecture that iteratively processes portions of a look-up table (LUT) in accordance with a fused single instruction stream, multiple data streams (SIMD) instruction. The LUT may contain segment entries that correspond to a result of evaluating a function using a corresponding index values, which represent an independent variable of the function. The index values are used to map data sample values in a data array that is to be interpolated to the segment entries. By using an iterative process of mapping data samples to valid segment entries contained in each LUT portion, the architecture advantageously facilitates scaling to support larger LUTs and thus may be expanded to enable linear interpolation on multiple dimensions.

### TECHNICAL FIELD

Techniques are described that generally relate to programmable processor array architectures and, in particular, to techniques for using such architectures to perform linear interpolation in multiple dimensions using a single instruction stream, multiple data streams (SIMD) instruction set.

### BACKGROUND

Programmable processing array architectures may leverage multidimensional look-up tables (LUTs) as part of the computations that are performed for various signal processing tasks. Typically, the values stored in the LUTs are used to perform some sort of interpolation in accordance with the signal processing computations. The most common of these interpolations is linear interpolation, which increases the smoothness of signal representation significantly and in a cost-effective manner Multidimensional LUTs can also be used to effectively model non-linear relations between different signals, with one practical example being for multi-band digital predistortion.

Previous solutions to implementing table lookups include the use of an SIMD instruction set for large ID LUT implementation. Moreover, previous solutions utilize parallel processing, but are limited to only ID table lookups and require a large number of instructions. Other techniques that implement multidimensional table lookups with interpolation have been implemented, but are based upon memory access and require special memory as well as a special memory addressing scheme. Thus, current techniques for performing multidimensional table lookups for programmable processing array architectures are inadequate.

### BRIEF DESCRIPTION OF THE DRAWINGS/FIGURES

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

FIG. 1 illustrates an example of a conventional vector processor architecture.

FIG. 2 illustrates another example of a conventional vector processor architecture.

FIG. 3 illustrates a block diagram of a programmable processing array architecture, in accordance with the disclosure.

FIG. 4 illustrates the use of 1-dimensional (1D) linear interpolation from stored lookup table values, in accordance with the disclosure;

FIG. 5 illustrates the use of 2-dimensional (2D) linear interpolation from stored lookup table values, in accordance with the disclosure;

FIG. 6A illustrates a look-up table (LUT), in accordance with the disclosure;

FIG. 6B illustrates a look-up table (LUT) that is larger than the LUT of FIG. 6A, in accordance with the disclosure;

FIG. 7 illustrates a conventional architecture and computational flow for performing 1D linear interpolation using accessed table values;

FIG. 8 illustrates an architecture and computational flow for performing linear interpolation using accessed table values, in accordance with the disclosure;

FIG. 9 illustrates a wireless device, in accordance with the disclosure; and

FIG. 10 illustrates a process flow, in accordance with the disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

The disclosure proposes a new instruction and hardware (HW) architecture to support efficient execution, which may be implemented to perform linear interpolation using table lookups in accordance with any suitable number of interpolation dimensions. An internal state selector is used to accumulate the result and reduce the overhead. Several instructions and HW enhancements are also introduced, and a procedure is provided to use proposed SIMD instructions to effectively extend the 1D case to calculate multidimensional table lookups.

The proposed microarchitecture and specialized fused instructions for 1D LUTs make large LUTs with interpolation much more efficient conventional solutions. Moreover, the additional extensions for multidimensional LUTs with interpolation enable efficient multidimensional LUTs computation with a reduced set of instructions and without special memory requirements, such as those implemented in conventional solutions.

### I. Programmable Processing Array Operational Overview

The programmable processing arrays as discussed in further detail herein may be implemented as vector processors or any other suitable type of array processors, of which vector processors are considered a specialized type. Such array processors may represent a central processing unit (CPU) that implements an instruction set containing instructions that operate on one-dimensional arrays of data referred to as data “vectors.” This is in contrast to scalar processors having instructions that operate on single data items. Vector processors can greatly improve performance on certain workloads, notably numerical simulation and similar tasks, by utilizing a number of execution units, which are alternatively referred to herein as cores, execution units processing units, functional units, or processing elements (PEs), and which independently execute specific functions on incoming data streams to achieve a processing flow.

Generally speaking, conventional CPUs manipulate one or two pieces of data at a time. For instance, conventional CPUs may receive an instruction that essentially says “add A to B and put the result in C,” with ‘C’ being an address in memory. Typically, the data is rarely sent in raw form, and is instead “pointed to” via passing an address to a memory location that holds the actual data. Decoding this address and retrieving the data from that particular memory location takes some time, during which a conventional CPU sits idle waiting for the requested data to be retrieved. As CPU speeds have increased, this memory latency has historically become a large impediment to performance.

Thus, to reduce the amount of time consumed by these steps, most modern CPUs use a technique known as instruction pipelining in which the instructions sequentially pass through several sub-units. The first sub-unit reads and decodes the address, the next sub-unit “fetches” the values at those addresses, while the next sub-unit performs the actual mathematical operations. Vector processors take this concept even further. For instance, instead of pipelining just the instructions, vector processors also pipeline the data itself. For example, a vector processor may be fed instructions that indicate not to merely add A to B, but to add all numbers within a specified range of address locations in memory to all of the numbers at another set of address locations in memory. Thus, instead of constantly decoding the instructions and fetching the data needed to complete each one, a vector processor may read a single instruction from memory. This initial instruction is defined in a manner such that the instruction itself indicates that the instruction will be repeatedly executed on another item of data, at an address one increment larger than the last. This allows for significant savings in decoding time.

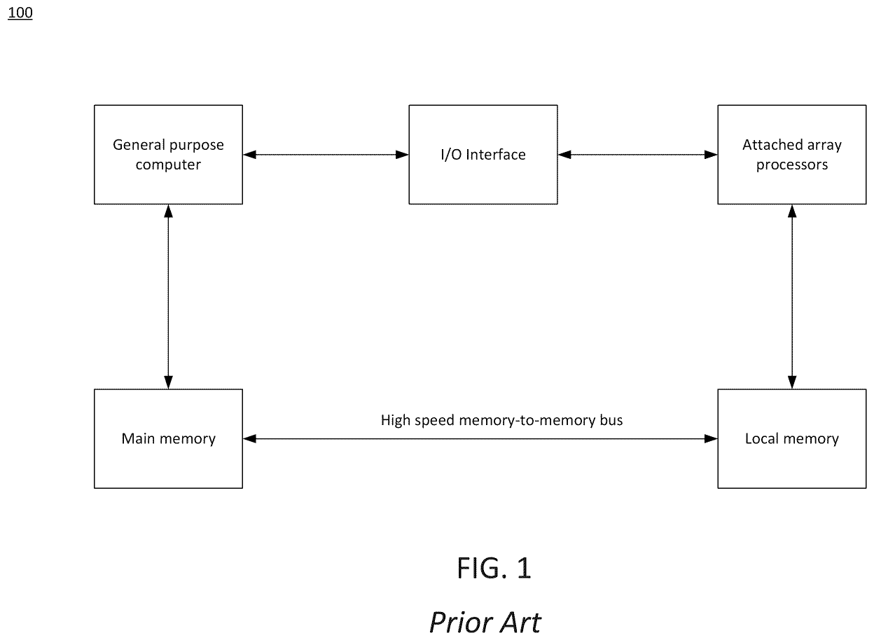

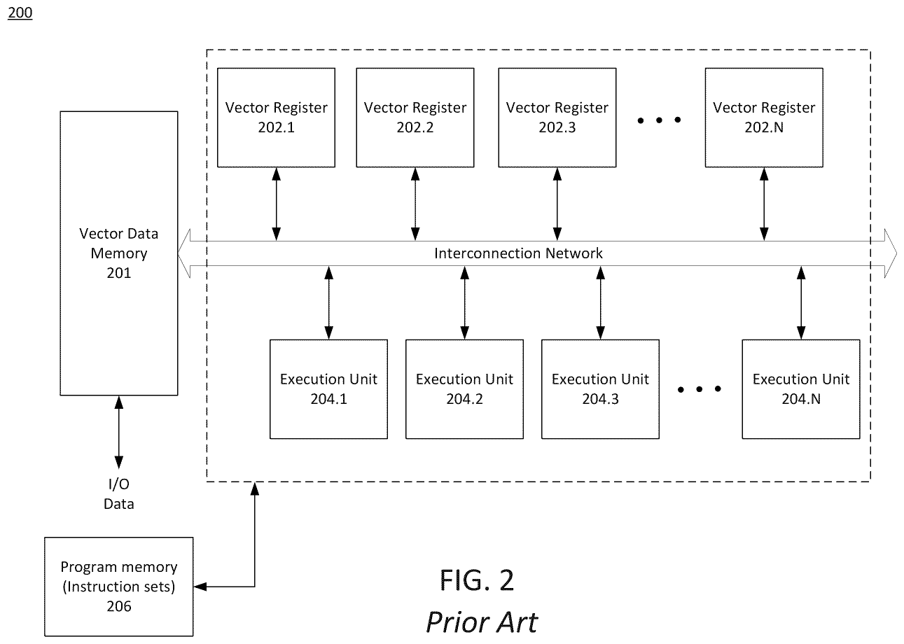

Vector processors may be implemented in accordance with various architectures, and the various programmable processing array architectures as discussed throughout the disclosure may be implemented in accordance with any of these architectures or combinations of these architectures, as well as alternative processing array architectures that are different than vector processors. FIGS. 1 and 2 provide two different implementations of a vector processor architectures. FIG. 1 illustrates an attached vector processor, which is attached to a general purpose computer for the purpose of enhancing and improving the performance of that computer in numerical computational tasks. The attached vector processor achieves high performance by means of parallel processing with multiple functional units.

FIG. 2, on the other hand, shows an example of a single instruction stream, multiple data streams (SIMD) vector processor architecture. The vector processor architecture 200 as shown in FIG. 2 may have an architecture consisting of one or more execution units 204.1-204.N. Each execution unit is capable of executing one instruction. Each instruction can be a control, load/store, scalar, or a vector instruction. Therefore, a processor architecture with N execution units 204.1-204.N as shown in FIG. 2 can issue as many as N instructions every clock cycle. The execution units 204.1-204.N function under the control of a common control unit (such as a processor or processing circuitry), thus providing a single instruction stream to control each of the execution units 204.1-204.N. The I/O data as shown in FIG. 2 is typically identified with data communicated between the vector processor 200 and another data source or processor (which may be the common control unit or another processor), depending upon the particular application. The vector data memory 201 thus stores data received as input to be processed by the execution units 204.1-204.N, and data that is output or read from the vector data memory 201 after the data is processed. The vector processor architecture 200 as shown in FIG. 2 is an example of a load-store architecture used by vector processors, which is an instruction set architecture that divides instructions into two categories: memory access (loading and storing data between the vector data memory 201 and the vector registers 202.1-202.N) and the vector processing operations performed by the execution units 204.1-204.N using the data retrieved from and the results stored to the vector registers 202.1-202.N.

Thus, the load-store instruction architecture facilitates data stored in the vector data memory 201 that is to be processed to be loaded into the vector registers 202.1-202.N using load operations, transferred to the execution units 204.1-204.N, processed, written back to the vector registers 202.1-202.N, and then written back to the vector data memory 201 using store operations. The location (address) of the data and the type of processing operation to be performed by each execution unit 204.1-204.N is part of an instruction stored as part of the instruction set in the program memory 206. The movement of data between these various components may be scheduled in accordance with a decoder that accesses the instructions sets from the program memory, which is not shown in further detail in FIG. 2 for purposes of brevity. The interconnection network, which supports the transfer of data amongst the various components of the vector processor architecture 200 as shown in FIG. 2, is generally implemented as a collection of data buses and may be shared among a set of different components, ports, etc. In this way, several execution units 204.1-204.N may write to a single vector register 202, and the data loaded into several vector registers 202.1-202.N may be read by and processed by several of the execution units 204.1-204.N. The use of instruction sets in accordance with the vector processor architecture 200 is generally known, and therefore an additional description of this operation is not provided for purposes of brevity.

Each of the digital data streams may include a set of N discrete data samples, which constitute the digital data that is to be subjected to the various processing operations as discussed in further detail herein. In some scenarios, the discrete data samples may correspond to data that is to be modulated and transmitted. Regardless of the particular implementation, the processing operations may include executing one or more mathematical functions to each of the N samples within a digital data stream. The specific mathematical functions may depend on the particular implementation, such as a digital pre-distortion (DPD) function that may be utilized by a particular transmitter architecture. The mathematical functions may be distilled into a table of coarse values having the table entries that represent a set of stored discrete data points. Each table entry may thus represent the result of evaluating a particular mathematical function using, as an independent variable of the continuous function, a respective discrete data sample.

This table of discrete data points may thus represent a range of function output values that correspond to specific points of discrete sample values within a range of data sample values. For example, if the DPD function is f(x)=x² and the data sample values are expected to vary between 0 to 4000, then the table may store values within a range of addressable memory such that each table entry contains an evaluated result corresponding to a discrete digital data sample value x. For instance, the first entry in the table may correspond to the evaluated result f(0) (i.e. the minimum value of the range of digital data stream sample values), whereas the last entry in the table may correspond to the evaluated result f(4000) (i.e. the maximum value of the range of digital data stream sample values).

However, to save memory space, it is preferable to condense the table entries stored in memory to a coarser representation of a smaller subset of data stream sample values. For instance, and using the example provided above, storing each evaluated value of f(x) incrementally by consecutive integer values f(0), f(1), f(2) . . . f(4000), would require a table with 4001 entries. Thus, it is advantageous to condense the size of this table to a coarser representation such as per increments of 10, 25, 50, 100, 250, etc., and then using linear interpolation to calculate the corresponding function outputs from the nearest set of discrete data points stored in the table within which a received data sample value falls. The determination of the granularity or coarseness of a table may be determined based upon a recognized tradeoff in accuracy and available memory.

Moreover, and as further discussed below, the techniques implemented herein may utilize a programmable processing array architecture, of which the vector processors as discussed herein are considered a specialized type. This architecture may be used to perform the linear interpolation calculations as discussed herein to evaluate a function in accordance with specific data sample values. Thus, unless otherwise specified, the term “linear interpolation” should not be interpreted as being limited to a single dimension or in accordance with a single variable. Instead, linear interpolation calculations as used herein may be applicable to single or multi-dimensional linear interpolations in accordance with any suitable number of dimensions and/or variables (e.g. bi-linear and tri-linear interpolation). The architecture and the functionality of this overall interpolation process is further discussed below.

### II. Programmable Processing Array Architecture

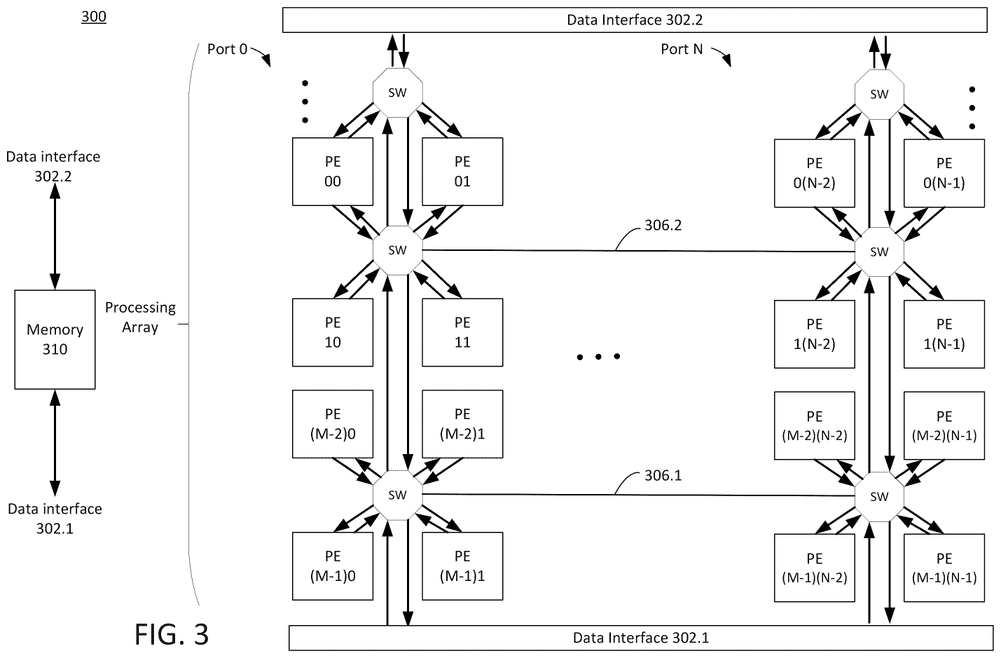

FIG. 3 illustrates a block diagram showing details of a portion of a programmable processing array architecture, in accordance with the disclosure. The architecture 300 as shown in FIG. 3 may also be referred to herein simply as a processing array, and may form part of a hybrid architecture that implements dedicated hardware blocks or as a standalone processing component. The programmable processing array architecture 300, when implemented as a vector processor architecture, may operate in the same manner as the vector processor architecture 200 as shown and discussed above with respect to FIG. 2. However, the programmable processing array architecture 300 is not limited to a vector processor architecture, and may be implemented in accordance with any suitable type of array-based processor architecture.

In any event, the processing array as shown in FIG. 3 may include any suitable number N of ports, with each port including any suitable number M of processing elements (PEs). Although each port is shown in FIG. 3 as including 8 PEs, this is for ease of explanation and brevity, and the processing array may include any suitable number of such PEs per port. Thus, the processing array may include a mesh of PEs, the number of which being equal to the number of PEs per port (M) multiplied by the total number of ports (N). Thus, for an illustrative scenario in which the processing array includes 8 ports and 8 PEs per port, the processing array would implement (M×N)=(8×8)=64 PEs. Moreover, in accordance with such a configuration, when implemented to perform wireless processing functions, each port may be identified with a respective antenna that is used as part of a multiple-input multiple-output (MIMO) communication system. Thus, the number of antennas used in accordance with such a system may be equal to the number N of ports, with each port being dedicated to a data stream transmitted and received per antenna.

Each of the PEs per port of the processing array may be coupled to the data interfaces 302.1, 302.2, and each PE may perform processing operations on an array of data samples retrieved via the data interfaces 302.1, 302.2. Access to the array of data samples by the PEs may be facilitated by any suitable configuration of switches (SW), as denoted in FIG. 3 via the SW blocks. The switches within each of the ports of the processing array may also be coupled to one another via interconnections 306.1, 306.2, with two being shown in FIG. 3 for the illustrative scenario of each port including 8 PEs. Thus, the interconnections 306.1, 306.2, function to arbitrate the operation and corresponding data flow of each grouping of 4 PEs within each port that are respectively coupled to each local port switch. The flow of data to a particular grouping of PEs and the selection of a particular port may be performed in accordance with any suitable techniques, including known techniques. In one illustrative scenario, this may be controlled by referencing a global system clock or other suitable clock via an system on a chip (SoC), network, system, etc., of which the processing array forms a part.

Thus, at any particular time, one or more of the PEs may be provided with and/or access an array of data samples provided on one of the data buses to perform processing operations, with the results then being provided (i.e. transmitted) onto another respective data bus. In other words, any number and combination of the PEs per port may sequentially or concurrently perform processing operations to provide an array of processed (i.e. output) data samples to another PE or to the data interfaces 302.1, 302.2 via any suitable data bus. The decisions regarding which PEs perform the processing operations may be controlled via operation of the switches, which may include the use of control signals in accordance with any suitable techniques to do so, including known techniques.

The data interfaces 302.1, 302.2 function as “fabric interfaces” to couple the processing array to other components of the architecture in which the processing array is implemented. Thus, the data interfaces 302.1, 302.2 are configured to facilitate the exchange of data between the PEs of the processing array, one or more hardware components such as the memory 310, hardware accelerators, an RF front end, and/or a data source. The data interfaces 302.1, 302.2 may thus be configured to provide data to the processing array that is to be processed and, when implemented as part of a transmitter, data that is to be transmitted. The data interfaces 302.1, 302.2 are configured to convert received data samples to arrays of data samples upon which the processing operations are then performed via the PEs of the processing array. The data interfaces 302.1, 302.2 are also configured to reverse this process, i.e. to convert the arrays of data samples back to a block or stream of data samples, as the case may be, which are then provided to one or more hardware components such as the memory 310, hardware accelerators, an RF front end, and/or a data source, etc.

The data interfaces 302.1, 302.2 may represent any suitable number and/or type of data interface that is configured to transfer data samples between any suitable data source and other components of the device in which the processing array is implemented. Thus, the data interfaces 302.1, 302.2 may be implemented as any suitable type of data interface for this purpose, such as a standardized serial interface used by data converters (ADCs and DACs) and logic devices (FPGAs or ASICs), and which may include a JESD-based standard interface and/or a chip-to-chip (C2C) interface. The data samples provided by the data source as shown in FIG. 3 may be in a data array format or provided as streaming (i.e. serial) data bit streams. In the latter case, the data interfaces 302.1, 302.2 may implement any suitable type and/or number of hardware and/or software components, digital logic, etc., to manage the translation of the streams of data bit samples to an array of data samples recognized and implemented via the processing array, and vice-versa.

In one scenario in which the processing array is implemented as part of a wireless communication device, each of the PEs in the processing array may be coupled to the data interfaces 302.1, 302.2 via any suitable number and/or type of data interconnections, which may include wired buses, ports, etc. The data interfaces 302.1, 302.2 may thus be implemented as a collection of data buses that couple each port (which may represent an individual channel or grouping of individual PEs in the processing array) to a data source via a dedicated data bus. Although not shown in detail in the Figures, in accordance with such scenarios each data bus may be adapted for use in a digital front end (DFE) used for wireless communications, and thus the dedicated buses may include a TX and an RX data bus per port in this non-limiting scenario.

The various techniques as discussed in further detail herein, which may utilize SIMD instructions to perform linear interpolation on any suitable number of dimensions, may be implemented with any suitable type of programmable processing array architecture. This may include the programmable processing array 300 as shown in FIG. 3 or, alternatively, the vector processing array architectures as shown in FIGS. 1 and 2. In any event, various techniques as discussed in further detail herein may be implemented in accordance with any suitable type of application that utilizes data interpolation (which is not limited to only linear interpolation) in accordance with any suitable predefined function that may be represented via entries stored in an addressable lookup table (LUT).

The data associated with the LUT entries as discussed in further detail herein may likewise be stored in any suitable portion of the processing architecture that is implemented. In an non-limiting and illustrative scenario, the LUTs may be stored in any suitable memory that is accessed by the processing elements of the programmable processing array to perform the various operations as discussed herein. This memory may comprise the vector data memory 201 as shown in FIG. 2. For other types of programmable processing array architectures, the LUT data may be stored in any suitable type of memory that is accessed via the processing elements of the programmable processing array. Thus, for the programmable processing array 300 as shown in FIG. 3, the LUT data entries may be stored in the memory 310, which are accessed by the PEs via communications via the data interfaces 302.1, 302.2. Alternatively, the LUTs may be stored in one or more register files, which may form part of the memory 310 or a separate component not shown in FIG. 3 for purposes of brevity, which may additionally be coupled to the data interfaces 302.1, 302.2 to enable the PEs to access data via read and write operations. The memory 310 may thus represent any suitable type of memory having any suitable addressable format for this purpose.

Regardless of the particular architecture, the processing elements of the programmable processing architecture may perform interpolation computations using the retrieved lookup values. The function that is evaluated in this manner may constitute part of or the entirety of a DPD function or other suitable function that provides the desired evaluated values for a particular application. To provide an illustrative and non-limiting scenario, if the DPD function is the expression f(x)=f(|xₙ|)·xₙ, then the interpolation computation may result in the processing elements calculating the portion f(|xₙ|). Continuing this example, the processing elements may additionally calculate the overall function evaluation f(x) by performing a multiplication of the interpolated result by the received data sample(s) associated with a particular digital data stream.

Such functions may be implemented as part of the digital signal processing operations for wireless communications, digital pre-distortion (DPD) coefficient calculations, average signal measurement calculations over time, digital signal processing of signals transmitted or received via individual antenna data streams for multiple-input-multiple-output (MIMO) antenna systems, filter tap calculations, etc.

It is noted that although the disclosure is described herein in terms of a programmable processing array architecture, this is a non-limiting and illustrative scenario. The techniques as described herein may be performed in accordance with any suitable type of processing architecture, including known types of processors, processor circuitry, and/or other suitable components. Moreover, although the use of linear interpolation is referenced throughout this disclosure, this is also a non-limiting and illustrative scenario, and the interpolation operations as described herein may be performed in accordance with any suitable type of linear or non-linear interpolation computations.

III. Overview of the use of lookup tables with linear interpolation

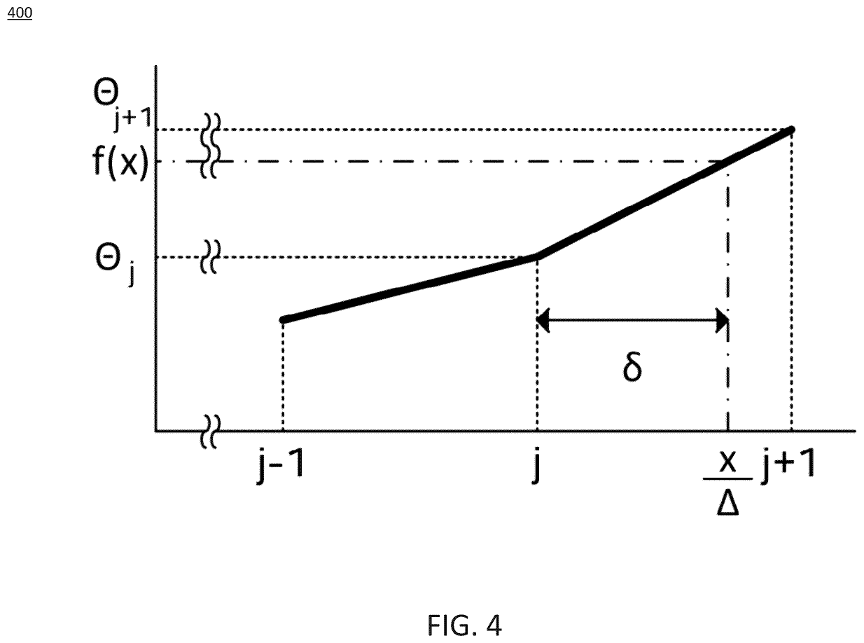

FIG. 4 illustrates a graph that demonstrates the use of linear interpolation from discrete values, in accordance with the disclosure. The graph 400 illustrates a continuous function f(x), with x representing a real valued number. The graph 400 defines a linear interpolation process in accordance with several defined terms, which are referenced below in further detail as part of the interpolation process. The linear interpolation process is discussed in further detail below, and may be implemented via a programmable processing array such as the one discussed above with respect to FIG. 3.

With reference to the graph 400, the function f(x) may be represented in accordance with Equation 1 below as follows:

f(x)=θⱼ_{^{sel}}+δ(θⱼ_{^{sel}}₊₁+θⱼ_{^{sel}}). Eqn. 1

With reference to both Equation 1 and graph 400, the following are defined as follows:
x represents a real valued number;
Δ represents the size of a lookup table segment;
N_{seg} represents the number of lookup table segments;
θⱼ represents the j-th lookup table value; generally j∈[0, N_{seg}];

$${j}_{s e l} = [ \frac{x}{Δ} ]$$

represents the selection of the index jₛₑₗ of the lower value of the segment; and

$$δ = \frac{x}{Δ} - {j}_{s e l}$$

represents the distance from the lower value.

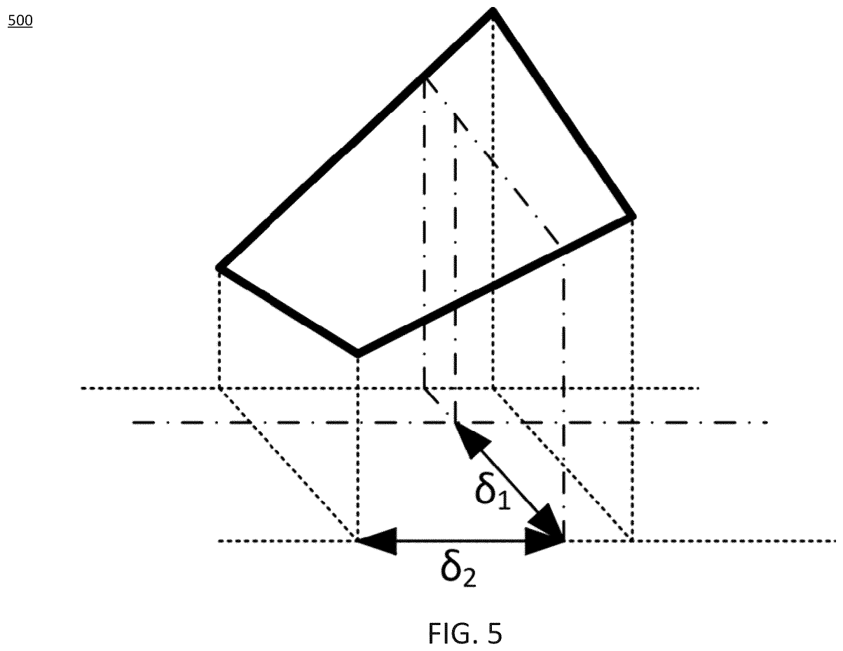

The techniques described in further detail herein may be extended to any suitable number of dimensions of linear interpolation. A 2-dimensional (2D) linear interpolation is illustrated in FIG. 5 and the accompanying graph 500. For the graph 500, two functions are defined in accordance with Equations 2-4 below as follows:

f₀=θⱼ_{₁}_{^{sel}}_{,j}_{₂}_{^{sel}}+δ₂(θⱼ_{₁}_{^{sel}}_{,j}_{₂}_{^{sel}}−θⱼ_{₁}_{^{sel}}_{,j}_{₁}_{^{sel}}_{,j}_{₂}_{^{sel}}); Eqn. 2

f₁=θⱼ_{₁}_{^{sel}}_{+1,j}_{₂}_{^{sel}}+δ₂(θⱼ_{₁}_{^{sel}}_{+1,j}_{₂}_{^{sel}}₊₁−θⱼ_{₁}_{^{sel}}_{+1,j}_{₂}_{^{sel}}); Eqn. 3

f(x₁,x₂)=f₀+δ₁(f₁−f₀), where: Eqn. 4
x₁, x₂ represents real valued numbers;
Δ₁, Δ₂ represent the sizes of a lookup table bins in two directions;
θⱼ_{₁}_{,j}_{₂} represents the lookup table value at the 2D grid position j₁, j₂

$${j}_{i}^{s e l} = [ \frac{{x}_{i}}{{Δ}_{i}} ]$$

represents the selection of the index j^{sel} of the lower value of the segment in the direction i; and

$${δ}_{i} = \frac{{x}_{i}}{{Δ}_{i}} - {j}_{i}^{s e l}$$

represents the distance from the lower value in the direction i.

The formulas can be extended to any N dimensional look up tables with linear interpolation. The data is thus fetched from the LUT (such as from a memory via a processing element as noted above) and interpolated along the first dimension, and the further dimensions are then used for further interpolations.

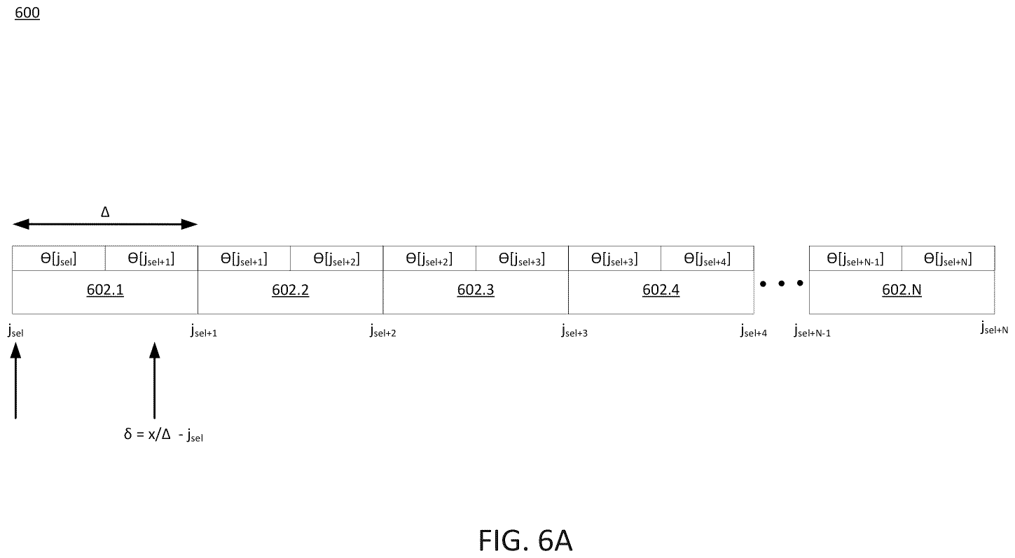

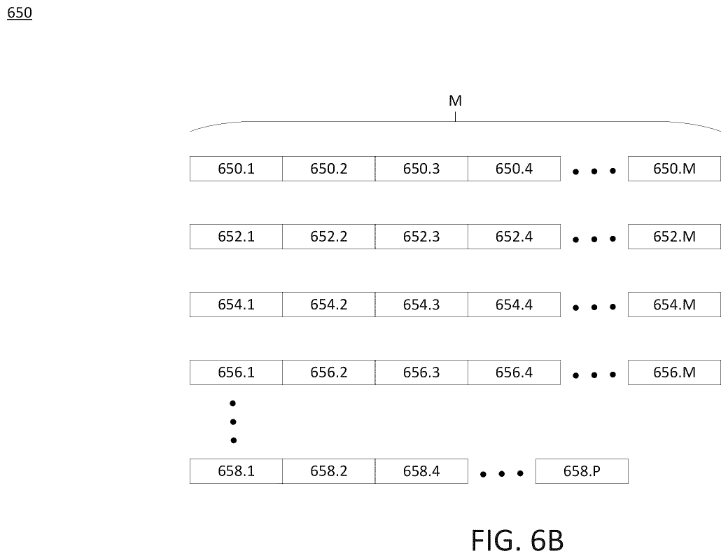

FIG. 6A illustrates a sample LUT format as a non-limiting and illustrative scenario to provide further clarity with respect to the interpolation operations as discussed herein. The LUT 600 as shown in FIG. 6A comprises any suitable number of N segments 602.1-602.N, which may alternatively be referred to herein as bins. Each segment 602.1-602.N comprises two entries, which include a lower segment entry and an upper segment entry. Using the segment 602.1 as a non-limiting and illustrative scenario, the lower segment entry comprises the evaluation of the real valued number jₛₑₗ (i.e. θ[ⱼ_{^{sel}}]), whereas the upper segment entry comprises the evaluation of the real valued number jₛₑₗ₊₁ (i.e. θ[ⱼ_{^{sel+1}}]). The real valued numbers jₛₑₗ and jₛₑₗ₊₁ may be referred to herein as an upper index value (or entry) and a lower index value (or entry), respectively. For brevity, the “sel” subscript may be omitted throughout the disclosure.

In other words, the graph 400 illustrates that the LUT index values j and j+1 correspond to respective real valued numbers x, which may represent the independent variables of a function, such as a continuous function. The LUT 600 also contains additional real valued numbers that correspond to the evaluation of these index values in accordance with the function f(x). Thus, the evaluation of these real valued numbers for the index values j and j+1 is shown in FIG. 4 as f(x)=θⱼ and θⱼ₊₁. The evaluated vales θⱼ and θⱼ₊₁ may be referred to herein as the lower and upper segment entries, respectively, as each segment of the LUT stored two entries in this manner. Thus, to perform the linear interpolation process, a determination is first made with respect to the upper and lower index values j and j+1 that span a data sample value, which thus identifies the range of segment entries, that is the lower and the upper segment entries, within which the sample value falls between. This is represented in FIG. 4 as the value x/Δ, which is expressed in terms of a proportion of the size of the LUT segment and is a distance from the lower index value j. Once the values for the segment entries θⱼ and θⱼ₊₁ are obtained via the corresponding index values, the unknown value for f(x) as shown in FIG. 4 may be calculated using a linear interpolation between the points (j, θⱼ) and (j+1, θⱼ₊₁), assuming linearity between these two points.

Thus, and turning now to FIG. 6A, the range of evaluated values f(x) (i.e. the segment entries) stored in each segment 602.1-602.N corresponds to the function outputs between the respective lower and the upper index values j and j+1 as shown. The interpolation operation as discussed in further detail herein may be performed between each respective lower segment entry θⱼ and upper segment entry θⱼ₊₁ based upon the value of x, which may be expressed as an offset value from the lower index value j in terms of a proportion of the segment size Δ as shown. In other words, the value δ is expressed in terms of the real valued number x as shown in FIG. 6A, and represents the fractional portion of the evaluated function f(x) within the range of values θⱼ and θⱼ₊₁. To provide a non-limiting and illustrative scenario for the segment 602.1 as shown in FIG. 6A, the lower index value jₛₑₗ may be 0, whereas the upper index value jₛₑₗ₊₁ may be 1. Thus, a value x of 0.75 may represent the fractional (three-quarters in this case) of the size of the segment 602.1, with the segment size Δ being equal to 1, and linear interpolation may then be performed to determine the value f(0.75)=θ[δ].

IV. Conventional use of SIMD Fused Instructions for Using a 1D Table Lookup with Linear Interpolation

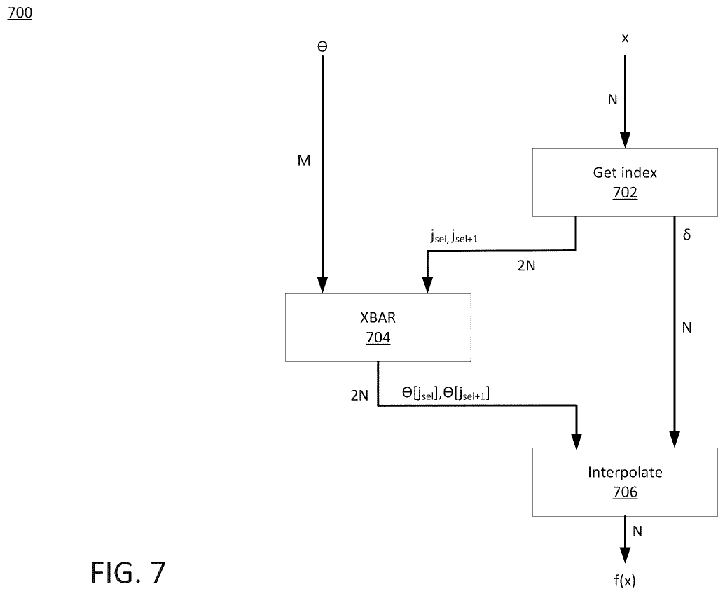

FIG. 7 illustrates a conventional architecture for performing linear interpolation using an N vector element SIMD operation. The conventional architecture comprises three compute blocks, which may be identified with HW blocks that execute their respective operations. The HW blocks as shown in FIG. 7 may be implemented as the execution units 204.1 as discussed above with respect to FIG. 2.

With continued reference to FIG. 7, x represents a real valued number having N number of elements, which may be alternatively referred to herein as data samples or simply as samples. Thus, x may be an array of samples (such as a vector) that together constitute a real valued number for which a linear interpolation operation is to be performed. The architecture 700 as shown in FIG. 7 comprises a dedicated get index HW block 702 that is configured to calculate the look-up table indexes jₛₑₗ, jₛₑₗ₊₁ for each sample of the array x. This may be performed, using the lower index jₛₑₗ as an example, in accordance with the relationship

$${j}_{s e l} = [ \frac{x}{Δ} ] ,$$

as noted above, to select the lower index value of the respective segment, as Δ may be a predefined and static value based upon the LUT format and design configuration.

Thus, the get index HW block 702 may be configured using knowledge of the size of each segment of the LUT in advance. In this way, the get index HW block 702 may use the size Δ of the LUT segments and the value of x to compute, for each sample in the array x, the lower index value s el Once known, this index value may be used to also determine the upper index value jₛₑₗ₊₁. Thus, the get index HW block 702 may receive a data vector x having N samples and compute, for each one of the N samples, a corresponding left index value jₛₑₗ and right index value jₛₑₗ₊₁. Again, these left and right index values may correspond to the lower and upper index values of a segment that spans the value of the data sample, as discussed above with respect to the LUT 600.

From each LUT segment, the get index HW block 702 also computes, for each sample in the array x, a corresponding value δ, which again represents the fractional portion of the evaluated function f(x) within the range of values for a particular segment. The get index HW block 702 may do so, for instance, using the relationship

$$δ = \frac{x}{Δ} - {j}_{s e l}$$

as noted above, with the jₛₑₗ and Δ values being computed and/or known as noted above. Thus, the get index HW block 702 also outputs, as shown in FIG. 7, an array of N data samples, each representing a corresponding value δ for each respective data sample of the array x.

Typically, the architecture 700 also implements further processing to provide the jₛₑₗ, jₛₑₗ₊₁, and δ value for each respective element of the array x. This may include, for example, “clipping” values to fall within a certain predetermined range. An example snippet of Python code that may be implemented for arrays of data is copied directly below for ease of explanation.

def get_index(x,N_seg,Delta):
#x>>log2(Delta)
j=np.floor(x/Delta):
#x−j<<log2(Delta)
delta=x−j*Delta
# border mode: nearest neighbor
j_1=np.minimum(j+1,N_seg−1)
return j,j_1,delta

The XBAR HW block 704 may be implemented as a common random access HW block. For the present application, a matching size may comprise an M to 2N mapping block, which may select any sample from the M inputs for any of the 2N outputs. The input of this block comprises the lookup table values, i.e. the segment values and index values, which corresponds to accessing M values from a LUT table having any suitable size. The XBAR HW block 704 is thus configured to map, for each one of the N samples in the array x, the indices jₛₑₗ, jₛₑₗ₊₁ to corresponding upper and lower segment entries stored in and retrieved from the LUT. Thus, the XBAR HW block 704 is configured to retrieve any suitable number of M entries contained within the segments of the LUT 600 as noted above. The number of entries retrieved in this manner is typically a function of the hardware configuration in which the architecture 700 is implemented. Thus, the XBAR HW block 704 may retrieve a number of LUT entries, which are used to match the index values with the index values of each respective segment of the LUT, and in turn to map the lower and upper index values jₛₑₗ, jₛₑₗ₊₁ for each segment to the respective lower and upper segment entries θⱼ_{ₛₑₗ}, θⱼ_{ₛₑₗ₊ᵢ}, which are output by the XBAR HW block 704 as shown in FIG. 7.

The output samples, i.e. the segment values (i.e. segment entries) θⱼ_{ₛₑₗ}, θⱼ_{ₛₑₗ₊ᵢ} as shown in FIG. 7, need to be finally interpolated. Thus, the interpolate HW block 706 is configured to receive these values for each of the N samples in the array x, which may have a size of 2N compared to the size of the data array x, as well as the calculated δ for each sample. The interpolate HW block 706 is configured to then perform an interpolation per sample, such as by way of the relationship of Equation 1 above, i.e. f(x)=θⱼ_{ₛₑₗ}+δ(θⱼ_{^{sel}}₊₁−θⱼ_{^{sel}}).

Specifically, the interpolate HW block 706 is configured to receive, for each of the samples of the x array, the lower and upper index values θⱼ_{ₛₑₗ}, θⱼ_{ₛₑₗ₊ᵢ}, which are associated with the lower and upper segment entries of a respective segment of the LUT as discussed above with respect to the LUT 600. Again, the interpolate HW block 706 receives, for each set of lower and upper segment entries θⱼ_{ₛₑₗ}, θⱼ_{ₛₑₗ₊ᵢ}, a respective δ value that represents the fractional portion of the x array element that is to be computed via interpolation. The interpolate HW block 706 is configured to output a “final” interpolated function f(x) for each respective sample of the array x, which represents the linear interpolation computation for each sample in the array x.

The operations described above may be fused into a single SIMD instruction to perform 1D table lookup with interpolation into a LUT of maximum 2N entries. Such an SIMD instruction may be represented as follows:

f=v_lut_interpolate(x,Theta_0_to_N−1,Theta_N_to_2N−1),

where the 2N table values are passed as two N element vectors Theta 0 to N−1, Theta_N_to_2N−1 holding the lower N and higher N elements each.

V. Extending the use of 1D Table Lookup with SIMD Instructions to Handle Larger Tables

The architecture as shown and discussed above with respect to FIG. 7 may use stored LUT segment entries to perform linear interpolation. However, the number of the LUT segments M that are accessed by the XBAR HW block 704 to perform the mapping processes are limited by the architecture of the programmable processing array. Thus, for typical systems M=2N, and therefore the data (i.e. the index values and segment entries) for only 2N segments (i.e. twice the number of data samples) of the LUT may be accessed by the XBAR HW block 704 at one time to perform the mapping process as discussed above.

But due to the limited number of LUT segments that mat may be accessed in this manner, the lower and upper index values identified by the get index HW block 702 may not be contained within the range of the accessed LUT segments. To provide an illustrative and non-limiting scenario, the LUT 600 may comprise a total of 256 segments, although only 64 LUT segments may be accessed by the XBAR HW block 704. Assuming that the size of each segment is 0.1, then the index values for the first 64 LUT segments may cover a range of x values between 0 and 6.4. For data samples having a value in excess of 6.4, the get index HW block 702 is unable to map the index values, as the data sample value is not contained within the 64 segments accessed by the XBAR HW block 704. Thus, the conventional architecture 700 as described with respect to FIG. 7 is not well suited for performing interpolation with larger LUT tables.

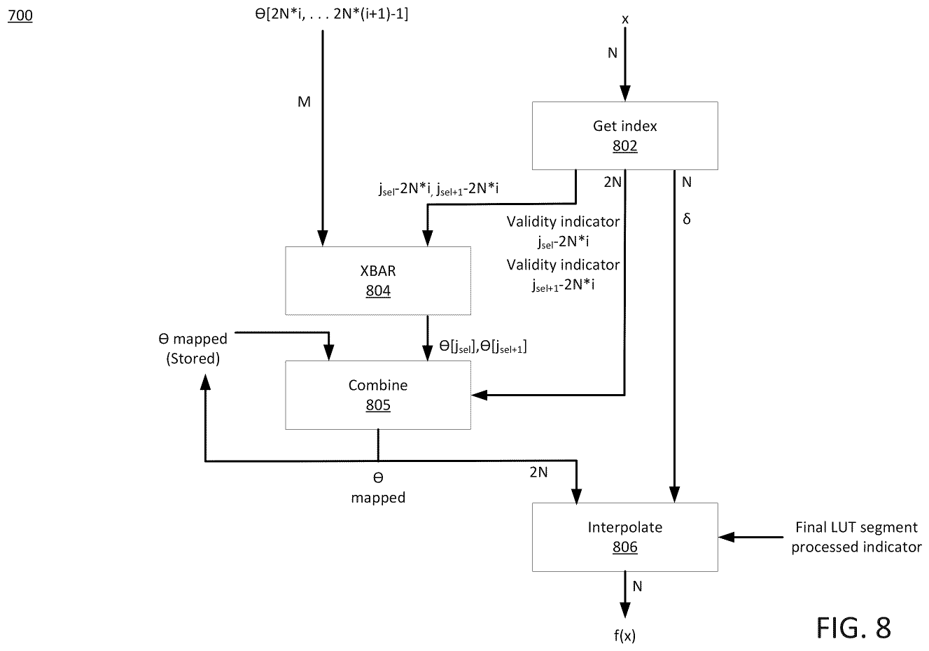

To address this issue, FIG. 8 illustrates an architecture and computational flow for performing linear interpolation using accessed table values, in accordance with the disclosure. The architecture 800 as shown in FIG. 8 comprises several dedicated HW blocks, which may operate in a similar manner as the respective HW blocks as shown and discussed above with respect to the conventional architecture 700 of FIG. 7. However, and as further discussed below, the “baseline” implementation of the architecture 700 may be extended with limited HW cost to handle LUTs with a larger number of segments. In particular, the architecture 800 may utilize any suitable number of K clock cycles throughput (K=1 for a fused instruction), which may be extended to a multi-instruction implementation in which each 2N additional samples require an additional K clock cycles and typically an additional instruction. The additional instruction may be avoided, however, via the use of an internal state machine.

Thus, the architecture 800 may function in a similar manner as the architecture 700 as described above, although the architecture 800 may include additional and alternative operations to accommodate the use of a larger LUT to perform linear interpolation operations in an efficient manner The various hardware blocks as shown and discussed with respect to the architecture 800 may be identified with any suitable hardware components, processing components, processing circuitry, etc. In a non-limiting and illustrative scenario, the architecture 800 may be implemented as part of a programmable processing array, such as the programmable processing array as shown and discussed herein with respect to FIG. 3, and may operate using any suitable instruction set architecture, such as the SIMD-based instruction set as discussed herein.

However, the architecture 800 is not limited to such implementations, and may be implemented accordance with any suitable processor-based architecture and/or instruction sets, which may include processor-array architectures or non-array based processor architectures. The hardware blocks as shown and described with respect to FIG. 8 may be identified with any suitable dedicated hardware components, and be collectively referred to herein as processing circuitry. The hardware blocks of the architecture 800 may, in some non-limiting and illustrative scenarios, be identified with any suitable portion of the programmable processing array 300, such as the various PEs as shown and described herein. The connections between the hardware blocks of the architecture 800 may be identified with any suitable number of buses, interconnections, wires, etc., such as the data interfaces 302.1, 302.2 as discussed above with respect to FIG. 3.

Thus, reference is now made to FIG. 6B, which illustrates a larger LUT 650 compared to the LUT 600 as shown in FIG. 6A. The LUT 650 may have the same format as the LUT 600 as shown in FIG. 6A. That is, the LUT 650 may comprise any suitable number of segments 650, 652, 654, 656, 658, etc., with each segment comprising lower and upper index values that are identified with an independent variable of a function, as well as respective lower and upper segment entries that are identified with the evaluation of the independent variables in accordance with that function. In other words, the lower segment entry and the upper segment entry of each one of the segments 602.1-602.N of the LUT 600 correspond to the result of evaluating a function using a corresponding lower index value and upper index value, respectively, which are stored in each respective segment of the LUT 650 and which represent an independent variable of the function.

Alternatively, each segment 602.1-602.N of the LUT 650 as shown in FIG. 6B may comprise a single segment entry, such that a duplication of entries across segments is avoided and less memory is needed. To provide an illustrative scenario, the “odd” segments 602.1, 602.3, etc. may contain a lower segment entry comprising the evaluation of the real valued number jₛₑₗ (i.e. θ[ⱼ_{^{sel}}]), whereas the “even” segments 602.2, 602.4, etc. may contain an upper segment entry comprising the evaluation of the real valued number jₛₑₗ₊₁ (i.e. θ[ⱼ_{^{sel+1}}]), as discussed above with respect to FIG. 6A. In other words, the values corresponding to the evaluation of Theta for each index value may be individually assigned to the segments of the LUT 650 or grouped into the various segments, with the latter resulting in nearly doubling the memory for the LUT 650 due to the repetition of the index values and corresponding segment values. Again, the LUT 650 as shown in FIG. 6B includes a larger number of segments compared to the LUT 600 as shown in FIG. 6A. Thus, the LUT 650 may comprise any suitable number of segment portions, each containing at most M number of segments. The LUT 650 may comprise a last portion of segments that is less than M, as shown in FIG. 6B. Each segment portion, such as the segments 650.1-650.M, 652.1-652.M, etc., may correspond to a different range of index values and segment entries. Thus, the LUT 650 may store segments 650.1-656.P, which cover a total range of index values (i.e. lower and upper index values) and corresponding segment entries (i.e. lower and upper segment entries). The last set of segments 658.1-658.P may comprise a number of segments equal to (i.e. P=M) or less than (i.e. P<M) the number of segment sin the other portions of the LUT 650. The portions of the LUT segments are further referenced below with respect to the architecture 800 as shown in FIG. 8. The XBAR HW block 804 may operate in a similar manner as the XBAR HW block 704 as

discussed above with respect to the architecture 700. However, the XBAR HW block 804 may repeatedly access a different portion of the LUT 650 comprising M number of segments (or less for the last portion of the LUT 650), and thus access the index values and segment entries for each of the segments in each LUT portion. It is noted that the XBAR HW block 804 may be implemented as any suitable type of selection network, and the inputs may be coupled to the selection network in any suitable manner to facilitate the XBAR HW block 804 fetching the required data from the LUT as discussed herein. Again, because the segments of the LUT may comprise individual segment and index values or multiple segment and index values, the XBAR HW block 804 may still fetch all the data needed in either case. However, when single segment and index values are stored per segment, the XBAR HW block 804 may fetch M-1 segments instead of M segments. In any event, the M number of segments may comprise any suitable number of segments that

may be a function of the hardware and/or datapath width in which the architecture 800 is implemented. Each portion of the LUT 650 that is accessed in this manner, i.e. each number of M segments or P segments, as the case may be, are processed one-by-one (i.e. portion-by-portion) and the results output by the XBAR HW block 804 are then accumulated, which is discussed in further detail below. That is, the total number of segments for a LUT may be represented as a size of K segments. Thus, the total number of portions is represented as ceil(K/(M)). If K is not a multiple of M, then the last portion will have P<M segments. The get index HW block 802 may likewise function in a similar manner as the get index HW

block 702 as described above. Thus, the get index HW block 802 may receive N number of data samples that form part of an array x. The get index HW block 802 may then determine, for each data sample, a corresponding lower index value jₛₑₗ−2N*i and a corresponding upper index value jₛₑₗ₊₁−2N*i that correspond to a respective segment of the portion of the LUT 650 that spans the value of each particular data sample. The get index HW block 802 may also output, for each data sample, a corresponding value δ, which again represents the fractional portion of the evaluated function f(x) within the range of values for a particular segment.

This process of determining the lower and upper index values, as well as the corresponding value δ, may be performed in the same manner as discussed above for the get index HW block 702. However, the notation “2N*i” is provided with respect to the current iteration and portion of the LUT 650 that is being processed by the XBAR HW block 804, and is provided for ease of explanation as it is referenced in further detail below as part of the pseudocode.

Thus, and as noted above with respect to the architecture 700, the XBAR HW block 804 is configured to map each one of the data samples in the array x to a corresponding lower segment entry and upper segment entry of the LUT (i.e. the e mapped values as shown in FIG. 8). To do so, the XBAR HW block 804 determines, for each one of the data samples, the lower segment entry θ[jₛₑₗ] and the upper segment entry θ[jₛₑₗ₊₁] based upon the corresponding lower index value jₛₑₗ and upper index value jₛₑₗ₊₁ of a respective segment of the LUT 650 that spans a range within which the data sample falls.

However, for a given array x of data samples, the corresponding indexes j and j+1 may correspond to different segments of the LUT 650, and these different segments may span across different portions of the LUT 650 than those currently accessed by the XBAR HW block 804. Thus, if the XBAR HW block 804 is, based on the instruction, operating on one portion of segments of the LUT 650, each index j and j+1 generated by the get index block 802 may or may not be contained within that particular range of segments. It is noted that the XBAR HW block 804 is only able to map the data samples to the correct corresponding segment entries (i.e. lower and upper segment entries) if the data sample value is within the range of lower and upper index values for one of the segments in the current portion of the LUT 650. Otherwise, the XBAR HW block 804 will compute arbitrary (i.e. invalid) values if the data sample is outside the range of any of the segments of the portion of the LUT that is currently being processed.

Thus, for each iteration (i.e. each portion of the M segments of the LUT 650 that are processed at any one time), the XBAR HW block 804 may map each of the data samples in the array to corresponding segment entries, but only a portion of these data samples may be within the range of segments covered by the currently processed portion of the LUT 650. Thus, for each iteration, i.e. for each portion of the LUT 650 that the XBAR HW block 804 uses to perform the mapping function, only part of the samples may be correctly (i.e. validly) mapped to lower and upper segment entries.

Therefore, the get index HW block 802 also calculates, for each sample in the array x that has been mapped to a corresponding lower segment entry and upper segment entry of a respective segment in the LUT, a set of validity indicators. The set of validity indicators may comprise a number 2N (i.e. one per computed index value per sample in the data array) of samples, each representing a binary indication of whether the corresponding lower index value and upper index value is valid. The validity indicator may indicate validity when a data sample is spanned by a lower index value and upper index value of the respective segment in the LUT, and otherwise indicate the resulting mapped lower segment entry and upper segment entries are invalid. The set of validity indicators may thus be used by the combine HW block 705 to accumulate the correctly mapped (i.e. valid) segment values for each of the data samples in the array x as all the portions of the LUT are iteratively traversed.

In other words, the XBAR HW block 804 performs an initial mapping of the samples in the array x to a first portion of the LUT 650, which may comprise a first M number of segments. The XBAR HW block 804 may then output the mapped lower and upper segment entries for each data sample in the array x using the range of values covered by the first M segments. Some of these mapped values may be valid while others may be invalid, and thus the combine HW block 705 uses the set of validity indicators to store and retain (i.e. not subsequently overwrite) the validly mapped lower and upper segment entries to a suitable memory location, which may comprise the memory 310, a register file, etc.

During each successive iteration, the XBAR HW block 804 outputs the mapped lower and upper segment entries for each data sample in the array x using the range of values covered by the second M segments, the third M segments, and so on. After each iteration, the combine HW block 705 stores the validly mapped lower and upper segment entries for each data sample (i.e. e mapped, as shown in FIG. 8), while overwriting previously-stored mapped values that were invalid with validly mapped values in subsequent iterations. Thus, the combine HW block 705 is configured to store, after each iteration, a corresponding lower segment entry and upper segment entry for each of the data samples for that specific portion of the LUT that are valid based upon the set of validity indicators. Moreover, by referencing the set of validity indicators, after each iteration the combine HW block 705 also maintains previously-stored validly mapped values when subsequently-mapped values are identified as invalid, while overwriting previously stored invalid entries with valid ones. Thus, the “loop” of storing validly mapped segment entries and overwriting previously identified invalid mapped segment entries with valid mappings (i.e. valid mappings from θ[jₛₑₗ], θ[jₛₑₗ₊₁]) continues until all portions of the LUT 650 have been processed by the XBAR HW block 804.

In this way, upon iteratively processing each portion of the LUT 650, the combine HW block 805 obtains validly mapped lower and upper segment entries for each data sample in the array x. In other words, upon completion of all iterations, i.e. upon all portions of the LUT 650 being processed, the combine HW block 805 is configured to provide a corresponding lower segment entry and upper segment entry for each of the data samples in the array x as a result of combining the validly mapped data samples from each iteration. Thus, due to the iterative nature of the XBAR HW block 804 and the combine HW block 805, the entire set of validly mapped lower and upper segments from the LUT 650 for each of the data samples in the array x are output by the combine HW block 805 upon the final portion of the LUT 650 being processed.

At this time, the interpolate HW block 806 is able to perform the linear interpolation operation for each data sample in the array x, as each data sample now has a validly mapped lower and upper segment value, as well as a corresponding value δ. The interpolate HW block 806 is thus configured to receive a control signal, which is indicated in FIG. 8 as the “final LUT segment processed indicator.” The control signal may represent a binary identifier that indicates whether the current portion of the LUT 650 that was processed by the XBAR HW block 804 contains the last portion of segments, i.e. the final portion of the LUT 650 has been processed by the XBAR HW block 804. In other words, the interpolate HW block 806 is configured to perform the linear interpolation operation in response to receiving the control signal, which indicates that the portion of the LUT 650 used to map the data samples of the array x includes the last segment of the LUT 650.

This control signal may be generated by any suitable component, such as a processor, an ASIC, one of the PEs of the programmable processing array, etc., within which the architecture 800 forms a part and which has knowledge of the operations performed by the programmable processing array. Thus, the control signal, when asserted, identifies to the interpolate HW block 806 that each mapped segment entry is now valid, and the interpolate HW block 806 only performs the linear interpolation operations when this is the case. Otherwise, the interpolate HW block 806 may be disabled and/or inactive and not perform operations on the 2N data samples received at its input.

As noted above for the architecture 700, the architecture 800 may likewise be implemented as part of a SIMD processor-based architecture, and thus perform the operations as described herein based upon a fused SIMD instruction having any suitable format and/or number of fields. That is, the fused SIMD instruction may instruct each of the get index HW block 802, the XBAR HW block 804, the combine HW block 805, and the interpolate HW block 806 to perform their respective operations as discussed herein. This may include the XBAR HW block 804 repeatedly mapping the data samples to segment values of different portions of the LUT 650, the combine HW block 805 combining the validly mapped segments from each of the iterations, the interpolate HW block 806 performing the linear interpolation operations, etc.

Thus, the pseudocode of the overall process may be provided with reference to the “i” indexes as shown in FIG. 8 as follows:

```
Theta_selected = [invalid,...,invalid] //2N invalid values at the start for
the selected values for i=0,..., ceil(N_seg /(2N)) // go over 2N sized
parts of the large LUT
{
      Calculate the indices and the valid bits for that part of the LUT
      Fetch the values from that part Theta[2N*i,...2N*(i+1)−1]
      including the invalid ones
      Combine to valid values with the previous values in Theta_selected
}
// now Theta_selected has all values with valid values and can be used for
interpolation
f(x)= interpolate(Theta_selected, delta)
```

Thus, for a SIMD-based processor architecture, the SIMD instructions may be implemented, as one non-limiting and illustrative scenario, as follows:
f, Theta_sel_0_to_N−1, Theta_sel_N_to_2N−1=v_lut_interpolate_part (x, i, Theta_2N*i_to_2N*i+N−1, Theta_2N*i+N_to_2N*(i+1)−1, Theta_sel_0_to_N−1, Theta_sel_N_to_2N−1)

Again, due to the use of the control signal, the instruction is updating the Theta_selected (i.e. Theta mapped values) each time for a new segment, and the final interpolated value f is only valid once all the segments are processed.

The Theta_selected values (i.e. mapped Theta values) may be passed to the instruction as above or maintained inside the HW as some internal state variable. Also, it is noted that passing the index and LUT segment values may be handled by internal states and a state machine performing the entire iterative procedure as described above.

VI. Multidimensional Lookup Tables with Interpolation

The iterative process described above with respect to the linear interpolation of data samples of an array x is with respect to a one-dimensional linear interpolation. In other words, the segment entries of the LUT 650 correspond to the evaluation of a single function f(x). However, this is by way of non-limitation and provided as an illustrative scenario for ease of explanation. Given the use of processing portions of the larger LUT 650 in an iterative manner, the architecture 800 lends itself well to performing linear interpolation using larger LUTs, and this concept may be exploited to expand the linear interpolation to any suitable number of additional dimensions. Thus, it is noted that as a multidimensional LUT is likely to have a larger number of segments, the portioned LUT access as described above may be particularly useful for multi-dimensional linear interpolation, although multidimensional linear interpolation may also be performed in a single iteration, in other alternative implementations.

In any event, the LUT 650 may be expanded to store segment entries and corresponding index values for additional functions to be evaluated, i.e. one function per interpolation dimension. Such a LUT may be referred to herein as a multidimensional LUT, and the architecture 800 as described herein may implement such a multidimensional LUT to perform linear interpolation using any suitable number of 1D LUT functions. In other words, the data samples that form part of the array x may be from among any suitable number of data arrays, with the architecture 800 performing linear interpolation as noted above on each of the data arrays as part of a multi-dimensional interpolation operation. To do so, the same components of the architecture 800 as described above may be implemented, with some extensions as described in further detail below.

Again, each segment of the LUT 650 as described above with respect to FIG. 6B may comprise individually assigned index and segment entry values or a set of such values (e.g. the upper and lower index values and corresponding segment entries). Moreover, in any event, a multi-dimensional function may be represented by corresponding multidimensional LUT values contained in such a LUT represented as θⱼ_{₁}_{^{sel}}_{,j}_{₂}_{^{sel}}_{. . .} . If the number of points along each one of the multiple dimensions is represented as K1, K2, . . . etc., then the LUT 650 may store segments per K dimension as a number of 1D sized arrays having a size of K=K1*K2* . . . , which may then be accessed via the portions of segments of size M as described above.

However, if each segment comprises upper and lower index values and corresponding segment entries, then the segments defined along the last dimension becomes K−1 segments. In this case, the borders of the multidimensional arrays have segments that contain the segment entries for different parts (i.e. different dimensions), and thus will need to be corrected. Thus, it may be particularly advantageous to implement the single index value and corresponding segment value per segment format for the 1D arrays when a multidimensional LUT is implemented, as doing so results in a memory savings while reducing the complexity of the interpolation computations. For this implementation, a notation is used that is referred to as point representation.

Thus, when expanding the above-described process to multidimensional linear interpolation scenarios, each of the N-dimensional indices may be computed and then converted to equivalent 1D indices. That is, an index in a multidimensional array may be converted to a linear index. To provide a non-limiting and illustrative scenario, for a 2D index j1 based on x1 and j2 based on x2, where j1 is in the range 0, . . . , N_seg_D1−1 and j2 is in the range 0, . . . , N seg D2−1, the linear index may be computed as:

j_lin=j1*N_seg_D2+j2

The range of the linear index j_lin is 0, . . . , N_seg_D1*N_seg_D2−1.

Thus, using the point representation for ease of explanation, the linear index for the second dimension may be computed as:

j_lin=j1*K2+j2, where K2 is the number of points in dimension 2, and so on.

For the multidimensional linear interpolation scenario, 2\hat{ }N_dimensions points need to be fetched per iteration. Thus, for the 2D case, 4 theta values (i.e. 4 mapped segment values, a lower and upper segment value for each data sample x) are needed to perform the first dimension interpolation in accordance with Equations 5 and 6 below as follows:

f₀=θⱼ_{₁}_{^{sel}}_{,j}_{₂}_{^{sel}}+δ₁(θⱼ_{₁}_{^{sel}}_{,j}_{₂}_{^{sel+1}}−θⱼ_{₁}_{^{sel}}_{,j}_{₂}_{^{sel}}) Eqn. 5

f₁=θθⱼ_{₁}_{^{sel}}_{+1,j}_{₂}_{^{sel}}+δ₂(θⱼ_{₁}_{^{sel}}_{+1,j}_{₂}_{^{sel}}₊₁−θⱼ_{₁}_{^{sel}}_{+1,j}_{₂}_{^{sel}}) Eqn. 6

This translates to 4 linear index values, 2 for the first interpolation:
j_lin0=j1*N_seg_D2+j2; and
j_lin1=j1*N_seg_D2+j2+1,
and 2 for the second interpolation:
j_lin2=(j1+1)*N_seg_D2+j2; and
j_lin3=(j1+1)*N_seg_D2+j2+1

The architecture 800 as discussed above may be implemented to perform these equivalent 1D lookups and interpolations along the second dimension. The indices may be computed in a dedicated HW block as part of the operation of the get index HW block 802, or alternatively computed externally by regular processor instructions.

Finally, the last step for the 2D linear interpolation LUT is interpolation between the first interpolated values in accordance with Equation 7 below as follows:

f(x₁,x₂)=f₀+δ₁(f₁−f₀) Eqn. 7

This operation may be performed by the interpolate HW block 806.

Alternatively, the computation of the multidimensional translation to a linear table may comprise the computation of an equivalent 1D x value as follows:
x_lin0=j1*N_seg_D2*Delta+x2; and
x_lin1=(j1+1)*N_seg_D2*Delta+x2.

Using these two values and the corresponding 2D LUT portion, the original instruction may be used to fetch the data that would be used to perform the first interpolation. That is, the portions of the LUT for the first dimension may be accessed in a similar manner as described above for the single dimension case, i.e. by iteratively processing each portion of the LUT 650 for the first dimension. However, instead of performing the interpolation, this process may then be repeated for the second dimensions as well as any further dimensions. Thus, at the end of the processing iterations for each dimension, each of the valid theta mapped values are stored in a suitable location, such as one or more register files. Upon this iterative process being completed for each dimension, the interpolate HW block 806 may then perform the final multi-dimensional interpolation in accordance with Equation 7 above.

### VII. An Electronic Device

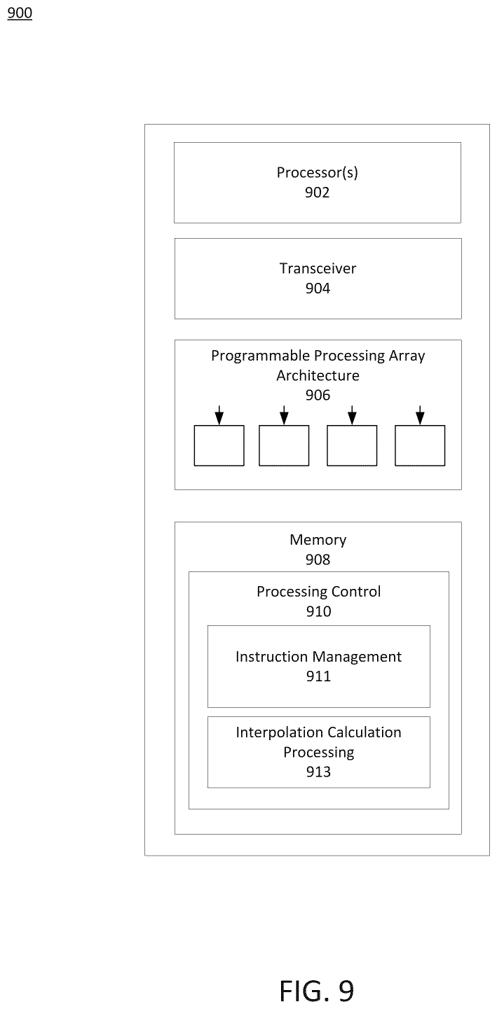

FIG. 9 illustrates an example device, in accordance with the present disclosure. The device 900 may be identified with one or more devices implementing a programmable processing array architecture to perform processing operations, such as the programmable processing array 300 as shown and discussed herein with reference to FIG. 3. The device 900 may be identified with a wireless device, a user equipment (UE) or other suitable device configured to perform wireless communications such as a mobile phone, a laptop computer, a cellular base station, a tablet, etc., which may include one or more components configured to transmit and receive radio signals. The programmable processing array 300 as discussed herein may facilitate, by way of its operation as discussed herein, the execution of any suitable number and/or type of processing operations that may be used as part of the transmission and/or reception of wireless signals via the electronic device 900. Thus, the processing operations may comprise any suitable type of digital signal processing in accordance with wirelessly transmitted and/or received data, which may include filter processing, digital front-end (DFE) processing, etc. Alternatively, the device 900 may be identified with a graphics processing unit (GPU), which may perform graphic processing on streams of graphical data.

As further discussed below, the device 900 may perform the functions as discussed herein with respect to the programmable processing array 300 as shown and discussed herein with reference to FIG. 3. The device 900 may perform processing operations by receiving processor instructions, such as SIMD instructions, having any suitable number of fields. These processing operations may be performed to receive data samples and output the result of performing data processing on the sets of data samples. To do so, the device 900 may include one or more processors 902, a transceiver 904, a programmable processing array architecture 906, and a memory 908. The components shown in FIG. 9 are provided for ease of explanation, and the device 900 may implement additional, less, or alternative components as those shown in FIG. 9. In one scenario, the transceiver 904 may be omitted when the device 900 is implemented as a GPU.

The processor(s) 902 may be configured as any suitable number and/or type of computer processors, which may function to control the device 900 and/or other components of the device 900. The processor(s) 902 may be identified with one or more processors (or suitable portions thereof) implemented by the device 900. The processor(s) 902 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processor(s) 902 may be configured to carry out instructions to perform arithmetical, logical, and/or input/output (I/O) operations, and/or to control the operation of one or more components of device 900 to perform various functions as described herein. The processor(s) 902 may include one or more microprocessor cores, memory registers, buffers, clocks, etc., and may generate electronic control signals associated with the components of the device 900 to control and/or modify the operation of these components. The processor(s) 902 may communicate with and/or control functions associated with the transceiver 904, the programmable processing array architecture 906, and/or the memory 908.

The transceiver 904 (when present) may be implemented as any suitable number and/or type of components configured to transmit and/or receive data (such as data packets) and/or wireless signals in accordance with any suitable number and/or type of communication protocols. The transceiver 904 may include any suitable type of components to facilitate this functionality, including components associated with known transceiver, transmitter, and/or receiver operation, configurations, and implementations. Although depicted in FIG. 9 as a transceiver, the transceiver 904 may include any suitable number of transmitters, receivers, or combinations of these that may be integrated into a single transceiver or as multiple transceivers or transceiver modules. The transceiver 904 may include components typically identified with an RF front end and include antennas, ports, power amplifiers (PAs), RF filters, mixers, local oscillators (LOs), low noise amplifiers (LNAs), upconverters, downconverters, channel tuners, etc.

Thus, the transceiver 904 may be configured as any suitable number and/or type of components configured to facilitate receiving and/or transmitting data and/or signals in accordance with one or more communication protocols. The transceiver 904 may be implemented as any suitable number and/or type of components to support wireless communications such as analog-to-digital converters (ADCs), digital to analog converters, intermediate frequency (IF) amplifiers and/or filters, modulators, demodulators, baseband processors, etc. The linear interpolation operations as discussed herein may be part of the digital signal processing operations that are implemented by the device 900 to facilitate the transceiver 904 transmitting data that has been subjected to such processing operations. These processing operations may comprise, as various non-limiting and illustrative scenarios, digital pre-distortion (DPD) coefficient calculations, average signal measurement calculations over time, digital signal processing of signals transmitted or received via individual antenna data streams for multiple-input-multiple-output (MIMO) antenna systems, filter tap calculations, etc. Thus, the data received via the transceiver 904 (e.g. wireless signal data streams), data provided to the transceiver 904 for transmission (e.g. data streams for transmission), and/or data used in conjunction with the transmission and/or reception of data via the transceiver 904 (e.g. digital filter coefficients, digital pre-distortion (DPD) terms, etc.) may be processed as data streams via the programmable processing array architecture 906 as part of its processing operations as discussed herein.

Thus, the programmable processing array architecture 906 may be identified with the programmable processing array 300, as well as the programmable processing array architecture 800, as shown and described herein with reference to FIGS. 3 and 8. In this way, the transceiver 904 may be configured to transmit and/or receive data signals based upon digital signal processing operations performed via the programmable processing array architecture 800, which again may be identified with the programmable processing array architecture 906.

The memory 908 is configured to store data and/or instructions such that, when the instructions are executed by the processor(s) 902, cause the device 900 to perform various functions as described herein with respect to the programmable processing array architecture 906, such as controlling, monitoring, and/or regulating the flow of data through the programmable processing array architecture 906. The memory 908 may be implemented as any suitable volatile and/or non-volatile memory, including read-only memory (ROM), random access memory (RAM), flash memory, a magnetic storage media, an optical disc, erasable programmable read only memory (EPROM), programmable read only memory (PROM), etc.

The memory 908 may be non-removable, removable, or a combination of both. The memory 908 may be implemented as a non-transitory computer readable medium storing one or more executable instructions such as, for example, logic, algorithms, code, etc.

As further discussed below, the instructions, logic, code, etc., stored in the memory 908 are represented by the various modules as shown, which may enable the functionality disclosed herein to be functionally realized. Alternatively, the modules as shown in FIG. 9 that are associated with the memory 908 may include instructions and/or code to facilitate control and/or monitor the operation of hardware components implemented via the device 900. In other words, the modules shown in FIG. 9 are provided for ease of explanation regarding the functional association between hardware and software components. Thus, the processor(s) 902 may execute the instructions stored in these respective modules in conjunction with one or more hardware components to perform the various functions as discussed herein.

The processing control engine 910 may represent the functionality described herein as discussed with reference to controlling and/or monitoring the programmable processing array architecture 906. The processing control engine 910 may represent a program memory (and stored instruction sets), a decoder, and/or the memory as discussed herein with reference to FIG. 3, and may alternatively or additionally comprise any suitable number of register files. Additionally or alternatively, one or more of the program memory, the decoder, and/or the register files may form part of the processor(s) 902, the memory 908, the programmable processing array architecture 906, or separate components not shown in FIG. 9.

The executable instructions stored in the instruction management module 911 may facilitate, in conjunction with execution via the processor(s) 902, the device 900 receiving and decoding processor instructions (which may be sent via the processor(s) 902 or other suitable component of the device 900 or a component external to the device 900), and providing data samples to the programmable processing array architecture 906. This may include a determination of each specific processor instruction to perform specific types of processing operations, such as the processing operations discussed herein that are executed by the architecture 800 to perform linear interpolation of data samples, and/or any of the functionality as discussed herein with respect to the programmable processing array 300 such as reading data samples from and writing data samples to memory and/or register files, the generation of processor instructions and/or control signals, the calculations identified with various processing operations, etc.

The executable instructions stored in the processing data management module 913 may facilitate, in conjunction with execution via the processor(s) 902, the determination of when the calculated results of interpolation operations are completed and when to store these results. This may include writing the results in one or more registers files to be utilized by the appropriate components of the device 900 or other suitable device.

### VIII. A Process Flow

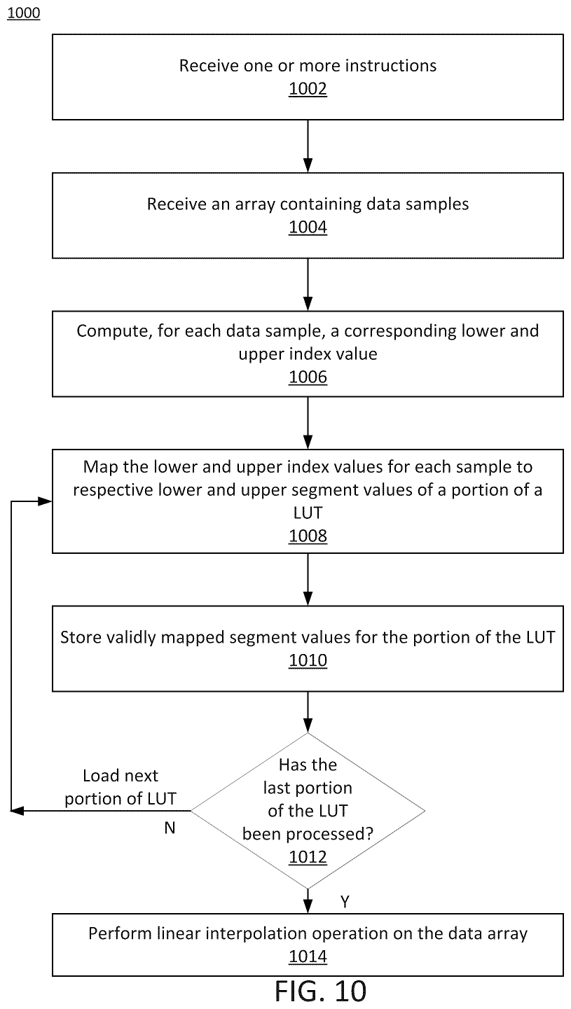

FIG. 10 illustrates a process flow. With reference to FIG. 10, the process flow 1000 may be executed by and/or otherwise associated with processing circuitry and/or storage devices. These processors and/or storage devices may be associated with one or more components of the programmable processing array 300, one or more components of the architecture 800, and/or one or more components of the device 900, as discussed herein. To provide an illustrative and non-limiting scenario, the process flow 1000 may be performed via the dedicated HW blocks of the architecture 800, as discussed in further detail herein with respect to FIG. 8. Additionally or alternatively, the processors and/or storage devices may be identified with the one or more PEs of the programmable processing array 300 and/or the processing circuitry 902, as discussed above. The flow 1000 may include alternate or additional steps that are not shown in FIG. 10 for purposes of brevity, and may be performed in a different order than the steps shown in FIG. 10.

Flow 1000 may begin with receiving (block 1002) one or more instructions. These instructions may be received, in one non-limiting and illustrative scenario, as a fused SIMD instruction having any suitable number of fields and/or format as discussed herein. The fused SIMD instruction may include the data that instructs each dedicated HW block to perform the various functions as discussed herein, which may additionally or alternatively form part of the process flow 1000.

The flow 1000 may include receiving (block 1004) an array of data samples, which may form part of an array x as discussed above with respect to FIG. 8.

The flow 1000 may include computing (block 1006), for each data sample in the array, a corresponding lower and upper index value j, as discussed above with respect to FIG. 8.

The flow 1000 may include mapping (block 1008), for each data sample and for a portion of segments of the LUT, each lower and upper index value to a corresponding lower and upper segment entry of the portion of the LUT. This may include, in one non-limiting and illustrative scenario, the operations performed by the XBAR HW block 804 as shown and discussed above with respect to FIG. 8.

The flow 1000 may include one or more processors storing (block 1010) the validly mapped segment values for the currently processed portion of the LUT to a suitable memory location, such as one or more register files. This may include, in one non-limiting and illustrative scenario, the operations performed by the combine HW block 805 as shown and discussed above with respect to FIG. 8.

The flow 1000 may include one or more processors determining (block 1012) whether the last portion of the LUT has been processed. This may include, in one non-limiting and illustrative scenario, the interpolate HW block 806 determining whether this is the case based upon the received control signal as shown and discussed above with respect to FIG. 8. If not, then the process flow 1000 may include the mapping (block 1008) of the lower and upper index values to corresponding segment values contained in segments of the next portion of the LUT. However, if the last portion of the LUT has been processed (i.e., the last segments), then it is presumed that all currently mapped segment values are now valid, and thus the linear interpolation operation is executed (block 1014) on the data array by using the mapped upper and lower segment values for each data sample as well as the corresponding δ value as shown and discussed above with respect to FIG. 8.

### IX. General Operation of a Programmable Processor Array

A programmable processing array is provided. The programmable processing array comprises a memory configured to store a plurality of segments identified with a lookup table (LUT); and processing circuitry configured to: for each one of a received plurality of data samples having a value that is within a range of values stored in segments of a portion of the LUT, map the data sample to an upper segment entry and a lower segment entry of a respective segment in the portion of the LUT that spans the data sample; repeatedly map each one of a received plurality of data samples for additional portions of the LUT to thereby map each one of the plurality of data samples to a corresponding upper segment entry and a lower segment entry of a respective segment in the LUT; and perform, for each one of the plurality of data samples, a linear interpolation operation based upon the respective upper segment entries and lower segment entries. In addition or in alternative to and in any combination with the optional features previously explained in this paragraph, the upper segment entry and the lower segment entry of each one of the segments of the LUT correspond to a result of evaluating a function using a corresponding upper index value and lower index value, respectively, stored in a respective segment of the LUT and which represent an independent variable of the function. In addition or in alternative to and in any combination with the optional features previously explained in this paragraph, the processing circuitry is configured to determine, for each of the plurality of data samples, a corresponding upper index value and lower index value of a respective segment of the portion of the LUT that spans the value of the respective data sample. In addition or in alternative to and in any combination with the optional features previously explained in this paragraph, the processing circuitry is configured map each one of the plurality of data samples to a corresponding upper segment entry and a lower segment entry of the LUT by determining, for each one of the plurality of data samples, the upper segment entry and the lower segment entry based upon the corresponding upper index value and lower index value of each respective segment of the LUT. In addition or in alternative to and in any combination with the optional features previously explained in this paragraph, the linear interpolation operation is performed in response to receiving a control signal that indicates that the portion of the LUT used to map the data samples of the array includes a last segment of the plurality of segments identified with the LUT. In addition or in alternative to and in any combination with the optional features previously explained in this paragraph, the processing circuitry is configured to determine whether each one of the plurality of data samples is spanned by an upper segment entry and a lower segment entry of a respective segment in the portion of the LUT based upon a set of validity indicators that indicate, for each of the plurality of data samples, a binary indication of whether each data sample is spanned by an upper index values and a lower index value of each of the segments identified with the portion of the LUT. In addition or in alternative to and in any combination with the optional features previously explained in this paragraph, the processing circuitry is configured to store, after each iteration, a corresponding upper segment entry and lower segment entry of each of the plurality of data samples for the portion of the LUT based upon the set of validity indicators. In addition or in alternative to and in any combination with the optional features previously explained in this paragraph, the processing circuitry is configured to provide a corresponding upper segment entry and a lower segment entry of each of the plurality of data samples for the LUT by combining the mapped data samples from each iteration. In addition or in alternative to and in any combination with the optional features previously explained in this paragraph, the processing circuitry is configured to repeatedly map the plurality of data samples and to perform the linear interpolation operation based upon receiving a single instruction stream, multiple data streams (SIMD) instruction. In addition or in alternative to and in any combination with the optional features previously explained in this paragraph, the plurality of data samples are part of a data array that is from among a plurality of data arrays, and the processing circuitry is configured to perform the linear interpolation operation as part of a multi-dimensional interpolation operation on the plurality of data arrays.

### X. General Operation of a Wireless Device

A wireless device is provided. The wireless device comprises a programmable processing array configured to: store a plurality of segments identified with a lookup table (LUT); and for each one of a received plurality of data samples having a value that is within a range of values stored in segments of a portion of the LUT, map the data sample to an upper segment entry and a lower segment entry of a respective segment in the portion of the LUT that spans the data sample; repeatedly map each one of a received plurality of data samples for additional portions of the LUT to thereby map each one of the plurality of data samples to a corresponding upper segment entry and a lower segment entry of a respective segment in the LUT; and perform, for each one of the plurality of data samples, a linear interpolation operation based upon the respective upper segment entries and lower segment entries; and a transceiver configured to transmit data that has been processed based upon the linear interpolation operation. In addition or in alternative to and in any combination with the optional features previously explained in this paragraph, the upper segment entry and the lower segment entry of each one of the segments of the LUT correspond to a result of evaluating a function using a corresponding upper index value and lower index value, respectively, stored in a respective segment of the LUT and which represent an independent variable of the function. In addition or in alternative to and in any combination with the optional features previously explained in this paragraph, the programmable processing array is configured to determine, for each of the plurality of data samples, a corresponding upper index value and lower index value of a respective segment of the portion of the LUT that spans the value of the respective data sample. In addition or in alternative to and in any combination with the optional features previously explained in this paragraph, the programmable processing array is configured map each one of the plurality of the data samples to a corresponding upper segment entry and a lower segment entry of the LUT by determining, for each one of the plurality of data samples, the upper segment entry and the lower segment entry based upon the corresponding upper index value and lower index value of each respective segment of the LUT. In addition or in alternative to and in any combination with the optional features previously explained in this paragraph, the linear interpolation operation is performed in response to receiving a control signal that indicates that the portion of the LUT used to map the data samples of the array includes a last segment of the plurality of segments identified with the LUT. In addition or in alternative to and in any combination with the optional features previously explained in this paragraph, the programmable processing array is configured to determine whether each one of the plurality of data samples is spanned by an upper segment entry and a lower segment entry of a respective segment in the portion of the LUT based upon a set of validity indicators that indicate, for each of the plurality of data samples, a binary indication of whether each data sample is spanned by an upper index values and a lower index value of each of the segments identified with the portion of the LUT. In addition or in alternative to and in any combination with the optional features previously explained in this paragraph, the programmable processing array is configured to store, after each iteration, a corresponding upper segment entry and lower segment entry of each of the plurality of data samples for the portion of the LUT based upon the set of validity indicators. In addition or in alternative to and in any combination with the optional features previously explained in this paragraph, the programmable processing array is configured to provide a corresponding upper segment entry and a lower segment entry of each of the plurality of data samples for the LUT by combining the mapped data samples from each iteration. In addition or in alternative to and in any combination with the optional features previously explained in this paragraph, the programmable processing array is configured to repeatedly map the plurality of data samples and to perform the linear interpolation operation based upon receiving a single instruction stream, multiple data streams (SIMD) instruction. In addition or in alternative to and in any combination with the optional features previously explained in this paragraph, the plurality of data samples are part of a data array that is from among a plurality of data arrays, and the programmable processing array is configured to perform the linear interpolation operation as part of a multi-dimensional interpolation operation on the plurality of data arrays.

### EXAMPLES

The following examples pertain to further aspects.

An example (e.g. example 1) is directed to a programmable processing array, comprising: a memory configured to store a plurality of segments identified with a lookup table (LUT); and processing circuitry configured to: for each one of a received plurality of data samples having a value that is within a range of values stored in segments of a portion of the LUT, map the data sample to an upper segment entry and a lower segment entry of a respective segment in the portion of the LUT that spans the data sample; repeatedly map each one of a received plurality of data samples for additional portions of the LUT to thereby map each one of the plurality of data samples to a corresponding upper segment entry and a lower segment entry of a respective segment in the LUT; and perform, for each one of the plurality of data samples, a linear interpolation operation based upon the respective upper segment entries and lower segment entries.

Another example (e.g. example 2) relates to a previously-described example (e.g. example 1), wherein the upper segment entry and the lower segment entry of each one of the segments of the LUT correspond to a result of evaluating a function using a corresponding upper index value and lower index value, respectively, stored in a respective segment of the LUT and which represent an independent variable of the function.

Another example (e.g. example 3) relates to a previously-described example (e.g. one or more of examples 1-2), wherein the processing circuitry is configured to determine, for each of the plurality of data samples, a corresponding upper index value and lower index value of a respective segment of the portion of the LUT that spans the value of the respective data sample.

Another example (e.g. example 4) relates to a previously-described example (e.g. one or more of examples 1-3), wherein the processing circuitry is configured map each one of the plurality of data samples to a corresponding upper segment entry and a lower segment entry of the LUT by determining, for each one of the plurality of data samples, the upper segment entry and the lower segment entry based upon the corresponding upper index value and lower index value of each respective segment of the LUT.

Another example (e.g. example 5) relates to a previously-described example (e.g. one or more of examples 1-4), wherein the linear interpolation operation is performed in response to receiving a control signal that indicates that the portion of the LUT used to map the data samples of the array includes a last segment of the plurality of segments identified with the LUT.

Another example (e.g. example 6) relates to a previously-described example (e.g. one or more of examples 1-5), wherein the processing circuitry is configured to determine whether each one of the plurality of data samples is spanned by an upper segment entry and a lower segment entry of a respective segment in the portion of the LUT based upon a set of validity indicators that indicate, for each of the plurality of data samples, a binary indication of whether each data sample is spanned by an upper index values and a lower index value of each of the segments identified with the portion of the LUT.

Another example (e.g. example 7) relates to a previously-described example (e.g. one or more of examples 1-6), wherein the processing circuitry is configured to store, after each iteration, a corresponding upper segment entry and lower segment entry of each of the plurality of data samples for the portion of the LUT based upon the set of validity indicators.

Another example (e.g. example 8) relates to a previously-described example (e.g. one or more of examples 1-7), wherein the processing circuitry is configured to provide a corresponding upper segment entry and a lower segment entry of each of the plurality of data samples for the LUT by combining the mapped data samples from each iteration.

Another example (e.g. example 9) relates to a previously-described example (e.g. one or more of examples 1-8), wherein the processing circuitry is configured to repeatedly map the plurality of data samples and to perform the linear interpolation operation based upon receiving a single instruction stream, multiple data streams (SIMD) instruction.

Another example (e.g. example 10) relates to a previously-described example (e.g. one or more of examples 1-9), wherein the plurality of data samples are part of a data array that is from among a plurality of data arrays, and wherein the processing circuitry is configured to perform the linear interpolation operation as part of a multi-dimensional interpolation operation on the plurality of data arrays.

An example (e.g. example 11) relates to a wireless device, comprising: a programmable processing array configured to: store a plurality of segments identified with a lookup table (LUT); and for each one of a received plurality of data samples having a value that is within a range of values stored in segments of a portion of the LUT, map the data sample to an upper segment entry and a lower segment entry of a respective segment in the portion of the LUT that spans the data sample; repeatedly map each one of a received plurality of data samples for additional portions of the LUT to thereby map each one of the plurality of data samples to a corresponding upper segment entry and a lower segment entry of a respective segment in the LUT; and perform, for each one of the plurality of data samples, a linear interpolation operation based upon the respective upper segment entries and lower segment entries; and a transceiver configured to transmit data that has been processed based upon the linear interpolation operation.

Another example (e.g. example 12) relates to a previously-described example (e.g. example 11), wherein the upper segment entry and the lower segment entry of each one of the segments of the LUT correspond to a result of evaluating a function using a corresponding upper index value and lower index value, respectively, stored in a respective segment of the LUT and which represent an independent variable of the function.

Another example (e.g. example 13) relates to a previously-described example (e.g. one or more of examples 11-12), wherein the programmable processing array is configured to determine, for each of the plurality of data samples, a corresponding upper index value and lower index value of a respective segment of the portion of the LUT that spans the value of the respective data sample.

Another example (e.g. example 14) relates to a previously-described example (e.g. one or more of examples 11-13), wherein the programmable processing array is configured map each one of the plurality of the data samples to a corresponding upper segment entry and a lower segment entry of the LUT by determining, for each one of the plurality of data samples, the upper segment entry and the lower segment entry based upon the corresponding upper index value and lower index value of each respective segment of the LUT.

Another example (e.g. example 15) relates to a previously-described example (e.g. one or more of examples 11-14), wherein the linear interpolation operation is performed in response to receiving a control signal that indicates that the portion of the LUT used to map the data samples of the array includes a last segment of the plurality of segments identified with the LUT.

Another example (e.g. example 16) relates to a previously-described example (e.g. one or more of examples 11-15), wherein the programmable processing array is configured to determine whether each one of the plurality of data samples is spanned by an upper segment entry and a lower segment entry of a respective segment in the portion of the LUT based upon a set of validity indicators that indicate, for each of the plurality of data samples, a binary indication of whether each data sample is spanned by an upper index values and a lower index value of each of the segments identified with the portion of the LUT.

Another example (e.g. example 17) relates to a previously-described example (e.g. one or more of examples 11-16), wherein the programmable processing array is configured to store, after each iteration, a corresponding upper segment entry and lower segment entry of each of the plurality of data samples for the portion of the LUT based upon the set of validity indicators.

Another example (e.g. example 18) relates to a previously-described example (e.g. one or more of examples 11-17), wherein the programmable processing array is configured to provide a corresponding upper segment entry and a lower segment entry of each of the plurality of data samples for the LUT by combining the mapped data samples from each iteration.

Another example (e.g. example 19) relates to a previously-described example (e.g. one or more of examples 11-18), wherein the programmable processing array is configured to repeatedly map the plurality of data samples and to perform the linear interpolation operation based upon receiving a single instruction stream, multiple data streams (SIMD) instruction.

Another example (e.g. example 20) relates to a previously-described example (e.g. one or more of examples 11-19), wherein the plurality of data samples are part of a data array that is from among a plurality of data arrays, and wherein the programmable processing array is configured to perform the linear interpolation operation as part of a multi-dimensional interpolation operation on the plurality of data arrays.

An example (e.g. example 21) is directed to a programmable processing array, comprising: a memory configured to store a plurality of segments identified with a lookup table (LUT); and processing means for: for each one of a received plurality of data samples having a value that is within a range of values stored in segments of a portion of the LUT, mapping the data sample to an upper segment entry and a lower segment entry of a respective segment in the portion of the LUT that spans the data sample; repeatedly mapping each one of a received plurality of data samples for additional portions of the LUT to thereby map each one of the plurality of data samples to a corresponding upper segment entry and a lower segment entry of a respective segment in the LUT; and performing, for each one of the plurality of data samples, a linear interpolation operation based upon the respective upper segment entries and lower segment entries.

Another example (e.g. example 22) relates to a previously-described example (e.g. example 21), wherein the upper segment entry and the lower segment entry of each one of the segments of the LUT correspond to a result of evaluating a function using a corresponding upper index value and lower index value, respectively, stored in a respective segment of the LUT and which represent an independent variable of the function.

Another example (e.g. example 23) relates to a previously-described example (e.g. one or more of examples 21-22), wherein the processing means determines, for each of the plurality of data samples, a corresponding upper index value and lower index value of a respective segment of the portion of the LUT that spans the value of the respective data sample.

Another example (e.g. example 24) relates to a previously-described example (e.g. one or more of examples 21-23), wherein the processing means maps each one of the plurality of data samples to a corresponding upper segment entry and a lower segment entry of the LUT by determining, for each one of the plurality of data samples, the upper segment entry and the lower segment entry based upon the corresponding upper index value and lower index value of each respective segment of the LUT.

Another example (e.g. example 25) relates to a previously-described example (e.g. one or more of examples 21-24), wherein the linear interpolation operation is performed in response to receiving a control signal that indicates that the portion of the LUT used to map the data samples of the array includes a last segment of the plurality of segments identified with the LUT.

Another example (e.g. example 26) relates to a previously-described example (e.g. one or more of examples 21-25), wherein the processing means determines whether each one of the plurality of data samples is spanned by an upper segment entry and a lower segment entry of a respective segment in the portion of the LUT based upon a set of validity indicators that indicate, for each of the plurality of data samples, a binary indication of whether each data sample is spanned by an upper index values and a lower index value of each of the segments identified with the portion of the LUT.

Another example (e.g. example 27) relates to a previously-described example (e.g. one or more of examples 21-26), wherein the processing means stores, after each iteration, a corresponding upper segment entry and lower segment entry of each of the plurality of data samples for the portion of the LUT based upon the set of validity indicators.

Another example (e.g. example 28) relates to a previously-described example (e.g. one or more of examples 21-27), wherein the processing means provides a corresponding upper segment entry and a lower segment entry of each of the plurality of data samples for the LUT by combining the mapped data samples from each iteration.

Another example (e.g. example 29) relates to a previously-described example (e.g. one or more of examples 21-28), wherein the processing means repeatedly maps the plurality of data samples and to perform the linear interpolation operation based upon receiving a single instruction stream, multiple data streams (SIMD) instruction.

Another example (e.g. example 30) relates to a previously-described example (e.g. one or more of examples 21-29), wherein the plurality of data samples are part of a data array that is from among a plurality of data arrays, and wherein the processing means performs the linear interpolation operation as part of a multi-dimensional interpolation operation on the plurality of data arrays.

An example (e.g. example 31) relates to a wireless device, comprising: a programmable processing array configured to: store a plurality of segments identified with a lookup table (LUT); and for each one of a received plurality of data samples having a value that is within a range of values stored in segments of a portion of the LUT, map the data sample to an upper segment entry and a lower segment entry of a respective segment in the portion of the LUT that spans the data sample; repeatedly map each one of a received plurality of data samples for additional portions of the LUT to thereby map each one of the plurality of data samples to a corresponding upper segment entry and a lower segment entry of a respective segment in the LUT; and perform, for each one of the plurality of data samples, a linear interpolation operation based upon the respective upper segment entries and lower segment entries; and a transceiving means for transmitting data that has been processed based upon the linear interpolation operation.

Another example (e.g. example 32) relates to a previously-described example (e.g. example 31), wherein the upper segment entry and the lower segment entry of each one of the segments of the LUT correspond to a result of evaluating a function using a corresponding upper index value and lower index value, respectively, stored in a respective segment of the LUT and which represent an independent variable of the function.

Another example (e.g. example 33) relates to a previously-described example (e.g. one or more of examples 31-32), wherein the programmable processing array is configured to determine, for each of the plurality of data samples, a corresponding upper index value and lower index value of a respective segment of the portion of the LUT that spans the value of the respective data sample.

Another example (e.g. example 34) relates to a previously-described example (e.g. one or more of examples 31-33), wherein the programmable processing array is configured map each one of the plurality of the data samples to a corresponding upper segment entry and a lower segment entry of the LUT by determining, for each one of the plurality of data samples, the upper segment entry and the lower segment entry based upon the corresponding upper index value and lower index value of each respective segment of the LUT.

Another example (e.g. example 35) relates to a previously-described example (e.g. one or more of examples 31-34), wherein the linear interpolation operation is performed in response to receiving a control signal that indicates that the portion of the LUT used to map the data samples of the array includes a last segment of the plurality of segments identified with the LUT.

Another example (e.g. example 36) relates to a previously-described example (e.g. one or more of examples 31-35), wherein the programmable processing array is configured to determine whether each one of the plurality of data samples is spanned by an upper segment entry and a lower segment entry of a respective segment in the portion of the LUT based upon a set of validity indicators that indicate, for each of the plurality of data samples, a binary indication of whether each data sample is spanned by an upper index values and a lower index value of each of the segments identified with the portion of the LUT.

Another example (e.g. example 37) relates to a previously-described example (e.g. one or more of examples 31-36), wherein the programmable processing array is configured to store, after each iteration, a corresponding upper segment entry and lower segment entry of each of the plurality of data samples for the portion of the LUT based upon the set of validity indicators.

Another example (e.g. example 38) relates to a previously-described example (e.g. one or more of examples 31-37), wherein the programmable processing array is configured to provide a corresponding upper segment entry and a lower segment entry of each of the plurality of data samples for the LUT by combining the mapped data samples from each iteration.

Another example (e.g. example 39) relates to a previously-described example (e.g. one or more of examples 31-38), wherein the programmable processing array is configured to repeatedly map the plurality of data samples and to perform the linear interpolation operation based upon receiving a single instruction stream, multiple data streams (SIMD) instruction.

Another example (e.g. example 40) relates to a previously-described example (e.g. one or more of examples 31-39), wherein the plurality of data samples are part of a data array that is from among a plurality of data arrays, and wherein the programmable processing array is configured to perform the linear interpolation operation as part of a multi-dimensional interpolation operation on the plurality of data arrays.

An apparatus as shown and described.

A method as shown and described.

### Conclusion

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processing circuitry” or “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

What is claimed is:

1. A programmable processing array, comprising:
a memory configured to store a plurality of segments identified with a lookup table (LUT); and
processing circuitry configured to:
for each one of a received plurality of data samples having a value that is within a range of values stored in segments of a portion of the LUT, map the data sample to an upper segment entry and a lower segment entry of a respective segment in the portion of the LUT that spans the data sample;
repeatedly map each one of a received plurality of data samples for additional portions of the LUT to thereby map each one of the plurality of data samples to a corresponding upper segment entry and a lower segment entry of a respective segment in the LUT; and
perform, for each one of the plurality of data samples, a linear interpolation operation based upon the respective upper segment entries and lower segment entries.

2. The programmable processing array of claim 1, wherein the upper segment entry and the lower segment entry of each one of the segments of the LUT correspond to a result of evaluating a function using a corresponding upper index value and lower index value, respectively, stored in a respective segment of the LUT and which represent an independent variable of the function.

3. The programmable processing array of claim 1, wherein the processing circuitry is configured to determine, for each of the plurality of data samples, a corresponding upper index value and lower index value of a respective segment of the portion of the LUT that spans the value of the respective data sample.

4. The programmable processing array of claim 3, wherein the processing circuitry is configured map each one of the plurality of data samples to a corresponding upper segment entry and a lower segment entry of the LUT by determining, for each one of the plurality of data samples, the upper segment entry and the lower segment entry based upon the corresponding upper index value and lower index value of each respective segment of the LUT.

5. The programmable processing array of claim 1, wherein the linear interpolation operation is performed in response to receiving a control signal that indicates that the portion of the LUT used to map the data samples of the array includes a last segment of the plurality of segments identified with the LUT.

6. The programmable processing array of claim 1, wherein the processing circuitry is configured to determine whether each one of the plurality of data samples is spanned by an upper segment entry and a lower segment entry of a respective segment in the portion of the LUT based upon a set of validity indicators that indicate, for each of the plurality of data samples, a binary indication of whether each data sample is spanned by an upper index values and a lower index value of each of the segments identified with the portion of the LUT.

7. The programmable processing array of claim 6, wherein the processing circuitry is configured to store, after each iteration, a corresponding upper segment entry and lower segment entry of each of the plurality of data samples for the portion of the LUT based upon the set of validity indicators.

8. The programmable processing array of claim 7, wherein the processing circuitry is configured to provide a corresponding upper segment entry and a lower segment entry of each of the plurality of data samples for the LUT by combining the mapped data samples from each iteration.

9. The programmable processing array of claim 1, wherein the processing circuitry is configured to repeatedly map the plurality of data samples and to perform the linear interpolation operation based upon receiving a single instruction stream, multiple data streams (SIMD) instruction.

10. The programmable processing array of claim 1, wherein the plurality of data samples are part of a data array that is from among a plurality of data arrays, and wherein the processing circuitry is configured to perform the linear interpolation operation as part of a multi-dimensional interpolation operation on the plurality of data arrays.

11. A wireless device, comprising:
a programmable processing array configured to:
store a plurality of segments identified with a lookup table (LUT); and
for each one of a received plurality of data samples having a value that is within a range of values stored in segments of a portion of the LUT, map the data sample to an upper segment entry and a lower segment entry of a respective segment in the portion of the LUT that spans the data sample;
repeatedly map each one of a received plurality of data samples for additional portions of the LUT to thereby map each one of the plurality of data samples to a corresponding upper segment entry and a lower segment entry of a respective segment in the LUT; and
perform, for each one of the plurality of data samples, a linear interpolation operation based upon the respective upper segment entries and lower segment entries; and
a transceiver configured to transmit data that has been processed based upon the linear interpolation operation.

12. The wireless device of claim 11, wherein the upper segment entry and the lower segment entry of each one of the segments of the LUT correspond to a result of evaluating a function using a corresponding upper index value and lower index value, respectively, stored in a respective segment of the LUT and which represent an independent variable of the function.

13. The wireless device of claim 11, wherein the programmable processing array is configured to determine, for each of the plurality of data samples, a corresponding upper index value and lower index value of a respective segment of the portion of the LUT that spans the value of the respective data sample.

14. The wireless device of claim of claim 13, wherein the programmable processing array is configured map each one of the plurality of the data samples to a corresponding upper segment entry and a lower segment entry of the LUT by determining, for each one of the plurality of data samples, the upper segment entry and the lower segment entry based upon the corresponding upper index value and lower index value of each respective segment of the LUT.

15. The wireless device of claim 11, wherein the linear interpolation operation is performed in response to receiving a control signal that indicates that the portion of the LUT used to map the data samples of the array includes a last segment of the plurality of segments identified with the LUT.

16. The wireless device of claim 11, wherein the programmable processing array is configured to determine whether each one of the plurality of data samples is spanned by an upper segment entry and a lower segment entry of a respective segment in the portion of the LUT based upon a set of validity indicators that indicate, for each of the plurality of data samples, a binary indication of whether each data sample is spanned by an upper index values and a lower index value of each of the segments identified with the portion of the LUT.

17. The wireless device of claim 16, wherein the programmable processing array is configured to store, after each iteration, a corresponding upper segment entry and lower segment entry of each of the plurality of data samples for the portion of the LUT based upon the set of validity indicators.

18. The wireless device of claim 17, wherein the programmable processing array is configured to provide a corresponding upper segment entry and a lower segment entry of each of the plurality of data samples for the LUT by combining the mapped data samples from each iteration.

19. The wireless device of claim 11, wherein the programmable processing array is configured to repeatedly map the plurality of data samples and to perform the linear interpolation operation based upon receiving a single instruction stream, multiple data streams (SIMD) instruction.

20. The wireless device of claim 11, wherein the plurality of data samples are part of a data array that is from among a plurality of data arrays, and
wherein the programmable processing array is configured to perform the linear interpolation operation as part of a multi-dimensional interpolation operation on the plurality of data arrays.
